(19) United States
(12) Patent Application Publication
(10) Pub. No.: US 2020/0385025 A1
(43) Pub. Date: Dec. 10, 2020

(54) INFORMATION PROCESSING APPARATUS, MOBILE APPARATUS, INFORMATION PROCESSING METHOD, AND PROGRAM

(71) Applicants: Sony Corporation, Tokyo (JP); Sony Semiconductor Solutions Corporation, kanagawa (JP)

(72) Inventors: Kiminobu NISHIMURA, Kanagawa (JP); Eiji OBA, Tokyo (JP); Masayuki YOKOYAMA, Tokyo (JP)

(73) Assignees: Sony Corporation, Tokyo (JP); Sony Semiconductor Solutions Corporation, Kanagawa (JP)

(21) Appl. No.: 16/955,076

(22) PCT Filed: Dec. 11, 2018
(86) PCT No.: PCT/JP2018/045515

§ 371 Date: Jun. 18, 2020

(30) Foreign Application Priority Data
Dec. 26, 2017 (JP) 2017-249709

(51) Int. Cl. B60W 60/00; G08G 1/16; B60W 50/14; B60W 40/08

(52) U.S. Cl. CPC B60W 60/0053; G08G 1/16; B60W 50/14; B60W 40/08; B60W 2540/22; B60W 2520/00; B60W 2540/221; B60W 2540/10; B60W 2540/12; B60W 60/001

(57) ABSTRACT

An arrangement is realized in which the motion sickness level of an occupant of a vehicle while automatic driving is being carried out is estimated, and in case the sickness level becomes equal to or larger than an existing standard value, a warning is output to prompt the occupant to change to manual driving, making it possible to return to safe manual driving. The detected information from an acceleration sensor is input and the sickness level of an occupant of a vehicle while automatic driving is being carried out is estimated. Furthermore, in case an estimated value and a warning output standard value are compared with each other and the estimated value becomes equal to or larger than the standard value, the outputting of a warning for prompting the occupant to switch from automatic driving to manual driving is executed. Moreover, a learning process based on operation information of an operator after the warning has been output is carried out.

### TECHNICAL FIELD

The present disclosure relates to an information processing apparatus, a mobile apparatus, an information processing method, and a program. More particularly, the present disclosure relates to an information processing apparatus that controls switching between automatic driving and manual driving, a mobile apparatus, an information processing method, and a program.

### BACKGROUND ART

Recently, much technical development has been underway with respect to automatic driving.

The automatic driving technology is a technology that enables a vehicle (automobile) to travel automatically on the road using various sensors such as position detecting means, etc. on the vehicle. It is expected that the automatic driving technology will become popular rapidly.

At present, however, the automatic driving is in a development stage and is considered to take time until it is capable of staying 100% in service. It is expected that for a while a vehicle with an automatic driving capability will travel by appropriately switching between automatic driving and manual driving by the operator (driver).

For example, it is expected that on roads that are more or less straight and sufficiently wide, e.g., on expressways or the like, the vehicle will travel in an automatic driving mode, whereas when the vehicle is to leave an expressway and to be parked at a desired position in a parking lot or when the vehicle is traveling on a mountain road with a reduced width, the vehicle will switch to a manual driving mode in which the operator (driver) controls the vehicle to travel.

While a vehicle is automatically driving, the operator (driver) is not required to direct its line of sight forwardly in the direction of travel of the vehicle, but can behave freely, e.g., can take a nap, watch TV, read a book, or look back and talk to a backseat passenger.

However, if while the vehicle is traveling the operator (driver) does not direct its line of sight forwardly in the direction of travel of the vehicle, but directs its line of sight in other directions, then the operator (driver) is likely to have a symptom of a car sickness (kinetosis). The symptom is caused by a mismatch between the change in the operator's body due to an acceleration of the vehicle or the like and the change in visual information about the direction of the line of sight.

At this point, in case the vehicle that travels by switching between the automatic driving and the manual driving is required to switch from the automatic driving mode to the manual driving mode, as described above, it is necessary for the operator (driver) to start the manual driving.

However, if the operator (driver) is suffering from a severe car sickness, then the operator (driver) is unable to perform normal manual driving. Switching to the manual driving mode in this state may possibly lead to an accident at worst.

Consequently, in case the vehicle switches from the automatic driving mode to the manual driving mode, the operator (driver) needs to be not in the state of a severe car sickness, but to be in a state capable of manually driving the vehicle normally.

Incidentally, PTL 1 (Japanese Patent Laid-Open No. 2012-59274) is available as art in the past disclosing a driving control arrangement for performing automatic driving to reduce a car sickness.

PTL 1 discloses an arrangement that has body condition detecting means for detecting a car sickness state of a vehicle occupant and controls automatic driving to drive the vehicle in a manner to make a car sickness less likely to happen in case the body condition detecting means detects a car sickness state of the vehicle occupant, and an arrangement for prompting the vehicle occupant to sleep.

Furthermore, PTL 2 (Japanese Patent Laid-Open No. 2006-034576) discloses an apparatus that determines whether an occupant of a vehicle is in a car sickness state or not and that if it is determined that the occupant is in a car sickness state, takes measures to eliminate a car sickness, e.g., opens the window, lowers the temperature, reproduces music, etc.

However, even though the driving control for reducing a car sickness as disclosed in PTL 1 is carried out, it is unable to solve a mismatch between the change in the operator's body due to an acceleration of the vehicle or the like and the change in visual information about the direction of the line of sight, and it is assumed that the possibility that the effect of reducing a car sickness will not be obtained is high.

In addition, if the operator (driver) falls asleep, it is freed from a car sickness, but the problem of delayed arrival at the destination arises.

Furthermore, in case the arrangement of PTL 2 is to be realized, it is necessary to install a new control apparatus for opening the window, lowering the temperature, reproducing music, etc. in the vehicle.

### CITATION LSIT

### Patent Literature

### [PTL 1]

Japanese Patent Laid-Open No. 2012-59274

### [PTL 2]

Japanese Patent Laid-Open No. 2006-034576

### [PTL 3]

Japanese Patent Laid-Open No. Hei 5-245149

### [PTL 4]

Japanese Patent No. 4882433

### SUMMARY

### Technical Problems

The present disclosure has been made in view of the above problems. It is an object of the present disclosure to provide an information processing apparatus, a mobile apparatus, and a method, and a program for preventing a operator (driver) from manually driving a vehicle while in a severe car sickness state and for safely switching from automatic driving to manual driving.

### Solution to Problems

A first aspect of the present disclosure resides in an information processing apparatus including:

a sickness level estimating section that is supplied with detected information input from an acceleration sensor included in a vehicle and estimates a motion sickness level of an occupant of the vehicle while automatic driving is being carried out;

a warning outputting necessity/unnecessity determining section that compares an estimated sickness level value estimated by the sickness level estimating section and a prescribed warning output standard value with each other; and

a warning outputting executing section that executes the outputting of a warning to prompt the occupant to change from automatic driving to manual driving in a case where the estimated sickness level value becomes equal to or larger than the warning output standard value.

A second aspect of the present disclosure resides in a mobile apparatus including:

an acceleration sensor for measuring an acceleration of the mobile apparatus;

a sickness level estimating section that is supplied with detected information input from the acceleration sensor and estimates a motion sickness level of an occupant of the mobile apparatus while automatic driving is being carried out;

a warning outputting necessity/unnecessity determining section that compares an estimated sickness level value estimated by the sickness level estimating section and a prescribed warning output standard value with each other; and

a warning outputting executing section that executes the outputting of a warning to prompt the occupant to change from automatic driving to manual driving in a case where the estimated sickness level value becomes equal to or larger than the warning output standard value.

A third aspect of the present disclosure resides in an information processing method to be carried out by an information processing apparatus, including:

a step of sickness level estimating in which a sickness level estimating section is supplied with detected information input from an acceleration sensor included in a vehicle and estimates a motion sickness level of an occupant of the vehicle while automatic driving is being carried out;

a step of warning outputting necessity/unnecessity determining in which a warning outputting necessity/unnecessity determining section compares an estimated sickness level value estimated by the sickness level estimating section and a prescribed warning output standard value with each other; and

a step of warning outputting executing in which a warning outputting executing section executes the outputting of a warning to prompt the occupant to change from automatic driving to manual driving in case the estimated sickness level value becomes equal to or larger than the warning output standard value.

A fourth aspect of the present disclosure resides in an information processing method to be carried out by a mobile apparatus, including:

a step in which an acceleration sensor measures an acceleration of the mobile apparatus;

a step of sickness level estimating in which a sickness level estimating section is supplied with detected information input from the acceleration sensor and estimates a motion sickness level of an occupant of the vehicle while automatic driving is being carried out;

a step of warning outputting necessity/unnecessity determining in which a warning outputting necessity/unnecessity determining section compares an estimated sickness level value estimated by the sickness level estimating section and a prescribed warning output standard value with each other; and

a step of warning outputting executing in which a warning outputting executing section executes the outputting of a warning to prompt the occupant to change from automatic driving to manual driving in case the estimated sickness level value becomes equal to or larger than the warning output standard value.

A fifth aspect of the present disclosure resides in a program for enabling an information processing apparatus to carry out information processing to cause:

a sickness level estimating section to carry out a step of sickness level estimating to be supplied with detected information input from an acceleration sensor included in a vehicle and estimate a motion sickness level of an occupant of the vehicle while automatic driving is being carried out;

a warning outputting necessity/unnecessity determining section to carry out a step of warning outputting necessity/unnecessity determining to compare an estimated sickness level value estimated by the sickness level estimating section and a prescribed warning output standard value with each other; and

a warning outputting executing section to carry out a step of warning outputting executing to execute the outputting of a warning to prompt the occupant to change from automatic driving to manual driving in case the estimated sickness level value becomes equal to or larger than the warning output standard value.

Note that the program according to the present disclosure is a program that can be provided through a storage medium or a communication medium in a computer-readable format to an information processing apparatus or a computer system that is capable of executing various program codes, for example. By providing the program in a computer-readable format, processing according to the program can be realized on the information processing apparatus or the computer system.

Other objects, features, and advantages of the present disclosure will become apparent from embodiments to be described later of the present disclosure and a more detailed description based on the accompanying drawings. Incidentally, in the present description, the term “system” means a logical collection of a plurality of apparatus, and is not limited to the arrangement in which the apparatus are present in the same housing.

### Advantageous Effects of Invention

According to an embodiment of the present disclosure, as described above, an arrangement is realized in which the motion sickness level of an occupant of a vehicle while automatic driving is being carried out is estimated, and in case the sickness level becomes equal to or larger than an existing standard value, a warning is output to prompt the occupant to change to manual driving, making it possible to return to safe manual driving.

Specifically, for example, detected information from an acceleration sensor is input and the sickness level of an occupant of a vehicle while automatic driving is being carried out is estimated. Furthermore, in case an estimated value and a warning output standard value are compared with each other and the estimated value becomes equal to or larger than the standard value, the outputting of a warning for prompting the occupant to switch from automatic driving to manual driving is executed. Moreover, a learning process based on operation information of an operator after the warning has been output is carried out. In case the operation is decided as a normal driving operation, a standard value updating process for increasing the standard value or the like is performed to make it possible to apply a standard value inherent in the operator.

With this arrangement, the sickness level of the occupant of the vehicle while automatic driving is being carried out is estimated, and in case the sickness level becomes equal to or larger than the existing standard value, a warning is output to prompt the occupant to change to manual driving, making it possible to return to safe manual driving.

Note that the advantage effects set forth in the present description are given by way of illustrative example only and are not restrictive, and additional advantages may be present.

### BRIEF DESCRIPTION OF DRAWINGS

FIG. 1 is a view illustrating an example of the configuration of a mobile apparatus according to the present disclosure.

FIG. 2 is a view illustrating an example of data displayed on a display unit of the mobile apparatus according to the present disclosure.

FIG. 3 is a diagram illustrating a sickness level estimating process carried out by the mobile apparatus according to the present disclosure.

FIG. 4 is a diagram illustrating the sickness level estimating process carried out by the mobile apparatus according to the present disclosure.

FIG. 5 is a diagram illustrating an example of the configuration of a data processor of the mobile apparatus according to the present disclosure.

FIG. 6 is a diagram illustrating a flowchart of the sequence of a process carried out by the data processor of the mobile apparatus according to the present disclosure.

FIG. 7 is a diagram illustrating a flowchart of the sequence of a process carried out by the data processor of the mobile apparatus according to the present disclosure.

FIG. 8 is a view illustrating an example of the configuration of a mobile apparatus according to the present disclosure.

FIG. 9 is a diagram illustrating an example of the configuration of a data processor of the mobile apparatus according to the present disclosure.

FIG. 10 is a view illustrating an example of the configuration of a mobile apparatus according to the present disclosure.

FIG. 11 is a diagram illustrating an example of the configuration of a data processor of the mobile apparatus according to the present disclosure.

FIG. 12 is a diagram illustrating an example of the configuration of a mobile apparatus according to the present disclosure.

FIG. 13 is a diagram illustrating an example of the configuration of the hardware of an information processing apparatus.

### DESCRIPTION OF EMBODIMENTS

Details of an information processing apparatus, a mobile apparatus, and an information processing method, and a program will be described hereinbelow with reference to the drawings. Incidentally, the description will be given according to the following items.

1. About Configuration and Processing of Mobile Apparatus and Information Processing Apparatus

2. About Specific Configurational Example and Processing Example Data Processor

3. About Embodiment Using Biological Sensor

4. About Embodiment Using Environmental Sensor

5. About Other Embodiments

6. About Configurational Example of Vehicle Control System in Mobile Apparatus

7. About Configurational Example of Information Processing Apparatus

8. Summarization of Configurations According to Present Disclosure

[1. About Configuration and Processing of Mobile Apparatus and Information Processing Apparatus]

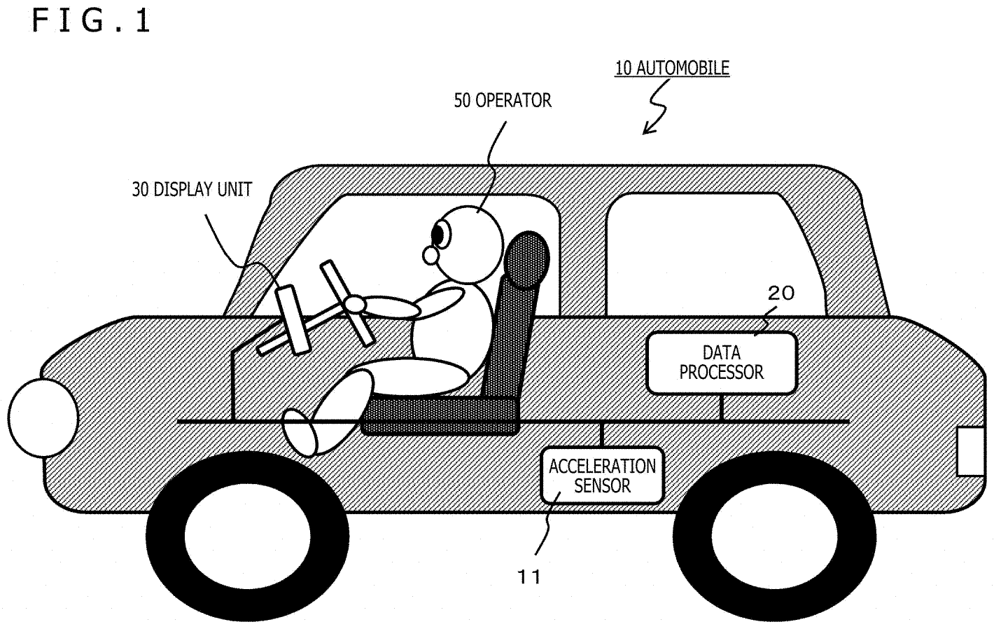

The configuration and processing of a mobile apparatus and an information processing apparatus according to the present disclosure will be described with reference to FIG. 1.

FIG. 1 is a view illustrating an example of the configuration of an automobile 10 as a mobile apparatus according to the present disclosure.

An information processing apparatus according to the present disclosure is incorporated in the automobile 10 illustrated in FIG. 1.

The automobile 10 illustrated in FIG. 1 is an automobile that can be driven in two driving modes including a manual driving mode and an automatic driving mode.

In the manual driving mode, the automobile 10 travels on the basis of an operation by an operator (driver) 50, i.e., an operation of a handle (steering) and an operation of an accelerator pedal, brake pedal, etc.

In the automatic driving mode, on the other hand, the automobile 10 requires no operation by the operator (driver) 50, but is driven on the basis of sensor information such as a position sensor and other peripheral information detection sensors, etc., for example.

The position sensor includes a GPS receiver or the like, for example, and the peripheral information detection sensors include an ultrasonic sensor, a radar, LiDAR (Light Detection and Ranging, Laser Imaging Detection and Ranging), a sonar, etc., for example.

Incidentally, FIG. 1 illustrates only those components that are required for the processing according to the present disclosure to be described below, i.e., major components used to switch between the driving modes including the automatic driving mode and the manual driving mode.

The configurations of sensors, etc. required for automatic driving are omitted. The configuration, including these sensors (detectors), of the automobile 10 in its entirety that performs automatic driving will be described later.

As illustrated in FIG. 1, the automobile 10 has an acceleration sensor 11, a data processor 20, and a display unit 30.

The acceleration sensor 11 detects acceleration of the automobile.

The data processor 20 corresponds to a major section of the information processing apparatus according to the present disclosure.

The data processor 20 is supplied with detected information input from the acceleration sensor 11, estimates a car sickness level of the operator 50 at the time of automatic driving, and outputs a warning (alarm) for prompting the operator to switch from automatic driving to manual driving in case the data processor 20 decides that the car sickness level of the operator 50 has reached a prescribed standard value.

Incidentally, in the description given hereinbelow, “sickness” means “vehicle sickness” such as “car sickness” or the like.

The warning (alarm) is executed as a warning that is displayed on the display unit 30 or a warning sound that is output, for example.

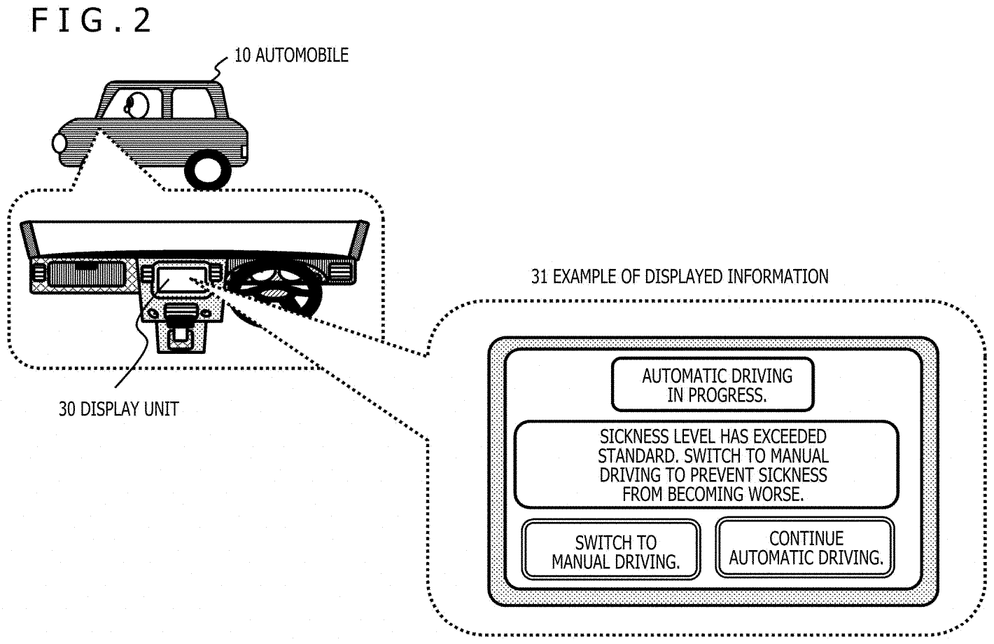

An example of a warning displayed on the display unit 30 is illustrated in FIG. 2.

As illustrated in FIG. 2, the display unit 30 puts on the following displays.

Driving mode information=“AUTOMATIC DRIVING IN PROGRESS.”

Warning display=“SICKNESS LEVEL HAS EXCEEDED STANDARD. SWITCH TO MANUAL DRIVING TO PREVENT SICKNESS FROM BECOMING WORSE.”

User selection areas=“SWITCH TO MANUAL DRIVING.” “CONTINUE AUTOMATIC DRIVING.”

The display area for driving mode information displays “AUTOMATIC DRIVING IN PROGRESS.” when the automatic driving mode is carried out, and displays “MANUAL DRIVING IN PROGRESS.” when the manual driving mode is carried out.

The display area for warning display information is a display area for displaying the information given below when the sickness level of the operator who is not driving becomes equal to or higher than a prescribed warning output standard value while the automobile is automatically driving in the automatic driving mode.

“SICKNESS LEVEL HAS EXCEEDED STANDARD. SWITCH TO MANUAL DRIVING TO PREVENT SICKNESS FROM BECOMING WORSE.”

Incidentally, the sickness level of the operator is calculated by the data processor 20 on the basis of the information about a temporal transition of the acceleration of the automobile that is measured by the acceleration sensor 11. This processing will be described later.

The user selection areas are input areas for selecting processes according to touches by the user (operator). The display unit 30 is constructed as a touch panel and can enter inputs according to touches by the user (operator).

In the illustrated example, two selection areas representing “SWITCH TO MANUAL DRIVING.” and “CONTINUE AUTOMATIC DRIVING.” are displayed.

If the user (operator) has selected “SWITCH TO MANUAL DRIVING.,” then after it has been detected that the user (operator) has started manual driving, a change from the automatic driving mode to the manual driving mode is executed.

On the other hand, if the user (operator) has selected “CONTINUE AUTOMATIC DRIVING.” then in case the user (operator) has not started manual driving, the automatic driving mode is continuously carried out.

As illustrated in FIG. 2, the display unit 30 executes the warning display “SICKNESS LEVEL HAS EXCEEDED STANDARD. SWITCH TO MANUAL DRIVING TO PREVENT SICKNESS FROM BECOMING WORSE.,” prompting the operator to start manual driving when the sickness level of the operator who is not driving becomes equal to or higher than the prescribed warning output standard value while the automobile is automatically driving in the automatic driving mode.

While the vehicle is automatically driving in the automatic driving mode, the operator (driver) is not required to direct its line of sight forwardly in the direction of travel of the vehicle, but can behave freely, e.g., can watch installed TV, read a book, or look back and talk to a backseat passenger.

However, if while the vehicle is traveling the operator (driver) does not direct its line of sight forwardly in the direction of travel of the vehicle, but directs its line of sight in other directions, then the operator (driver) is likely to have the symptom of a car sickness (kinetosis). The symptom is caused by a mismatch between the change in the operator's body due to an acceleration of the vehicle or the like and the change in visual information about the direction of the line of sight.

One of methods of eliminating the car sickness is to perform manual driving. When the operator (driver) starts manual driving, it directs its line of sight forwardly in the direction of travel of the vehicle. This process results in a match between the change in the operator's body due to an acceleration of the vehicle or the like and the change in visual information about the direction of the line of sight, eliminating the car sickness.

However, if the operator (driver) has fallen into a severe car sickness state while the vehicle is traveling in the automatic driving mode, then even though the operator (driver) wants to switch from automatic driving to manual driving, there may arise a situation in which the operator (driver) is unable to perform normal manual driving. Switching to the manual driving mode in this state may possibly lead to an accident at worst.

With the configuration according to the present disclosure, in order to prevent such an unexpected situation from occurring, the sickness level of the operator who is not driving is estimated while automatic driving is being carried out in the automatic driving mode. Furthermore, the estimated value and the prescribed warning output standard value are compared with each other, and if it is decided that the estimated sickness level value becomes equal to or higher than the warning output standard value, the warning illustrated in FIG. 2 is output.

Specifically, the display unit 30 executes the warning display “SICKNESS LEVEL HAS EXCEEDED STANDARD. SWITCH TO MANUAL DRIVING TO PREVENT SICKNESS FROM BECOMING WORSE.,” prompting the operator to start manual driving.

This processing makes it possible to switch from automatic driving to manual driving before the operator (driver) reaches a severe car sickness state, thereby realizing safe traveling.

In case the above process is to be carried out, processes of:

calculating an estimated sickness level value by estimating a sickness level of the operator;

setting a warning output standard value as a standard for determining whether a warning is to be output or not; and

comparing the estimated sickness level value of the operator and the warning output standard value with each other, and outputting a warning based on the comparison result;

are required.

These processes are carried out by the data processor 20.

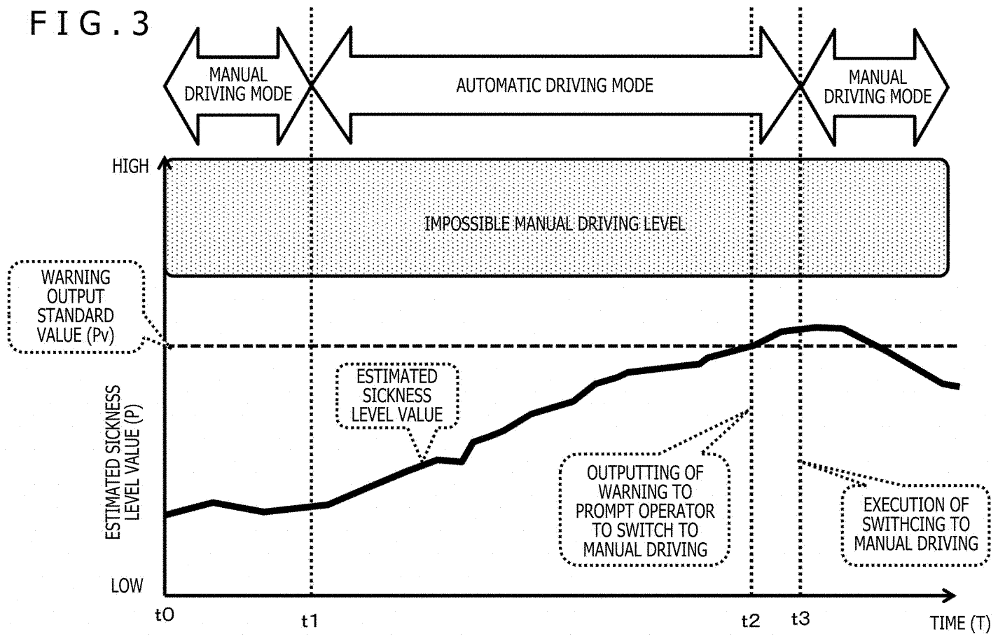

An example of a temporal transition of the sickness level of the operator will be described below with reference to FIG. 3.

FIG. 3 illustrates a graph having a horizontal axis representing “time (T)” and a vertical axis representing “estimated sickness level value (P).”

The period from time t0 to time t1 is a period in which the operator is manually driving the vehicle.

The subsequent period from time t1 to time t3 is a period in which automatic driving is executed.

Time t2 is a time at which the data processor 20 compares the estimated sickness level value (P) of the operator who is not driving and a prescribed warning output standard value (Pv) with each other and decides that the estimated sickness level value (P) is equal to or higher than the warning output standard value (Pv). The data processor 20 outputs the warning illustrated in FIG. 2 at time t2.

Thereafter, the operator starts manual driving at time t3.

A curve represented by a bold line in FIG. 3, which gradually rises as time passes, indicates an example of a transition of the estimated sickness level value (P) of the operator as time passes.

In the example illustrated in FIG. 3, the estimated sickness level value (P) gradually rises in the period from time t1 to time t3 in which automatic driving is executed.

As described hereinbefore, while the vehicle is executing automatic driving, the operator (driver) often does not direct its line of sight forwardly in the direction of travel of the vehicle, but performs other tasks. Therefore, the change in the operator's body due to an acceleration of the vehicle or the like and the change in visual information about the direction of the line of sight do not match each other. As a result, the operator (driver) is likely to have the symptom of a car sickness (kinetosis).

At time t2, the “estimated sickness level value (P)” becomes equal to or higher than the prescribed “warning output standard value (Pv).” At time t2, the data processor 20 outputs the warning illustrated in FIG. 2.

When the operator starts manual driving at subsequent time t3, the “estimated sickness level value (P)” is gradually lowered.

This indicates that as manual driving starts, since the operator (driver) directs its line of sight forwardly in the direction of travel of the vehicle, the change in the operator's body due to an acceleration of the vehicle or the like and the change in visual information about the direction of the line of sight match each other, gradually eliminating the sickness.

The “estimated sickness level value (P)” represents an estimated value that the data processor 20 calculates on the basis of acceleration information input from the acceleration sensor 11.

A process of estimating a sickness level based on an acceleration may use the following existing technology, for example.

the process prescribed in “ISO2361-1 (1997)” or the process described in “This Wiederkehr, Friedhelm Altpeter, “Review of Motion Sickness Evaluation Methods and their application to Simulation Technology,” SIMPACK News July 2013, pp. 12-15, 2013.”

These existing processes can be applied.

For example, ISO2361-1 (1997) prescribes

MSDVz (Motion Sickness Dose Value)

as an index value of a sickness level calculated on the basis of acceleration information.

A procedure for calculating MSDVz will be described below.

Incidentally, MSDVz represents data calculated as an index value of a sea sickness, and indicates a sickness level index value calculated on the basis of an acceleration of a vertical component often generated on ships.

The sickness level index value (MSDVz) prescribed by ISO2361-1 (1997) can be calculated using exposure time T of an acceleration by the following equation (Equation 1).

### [Math. 1]

MSDV_{z}=\sqrt{∫₀^{T}α_{f}²·dt} (Equation 1)

In the above (Equation 1), T represents the exposure time (seconds) of the acceleration, i.e., the time under the influence of the acceleration.

af represents a vertical instantaneous acceleration value corrected according to a Wf filter prescribed in ISO2361-1 (1997).

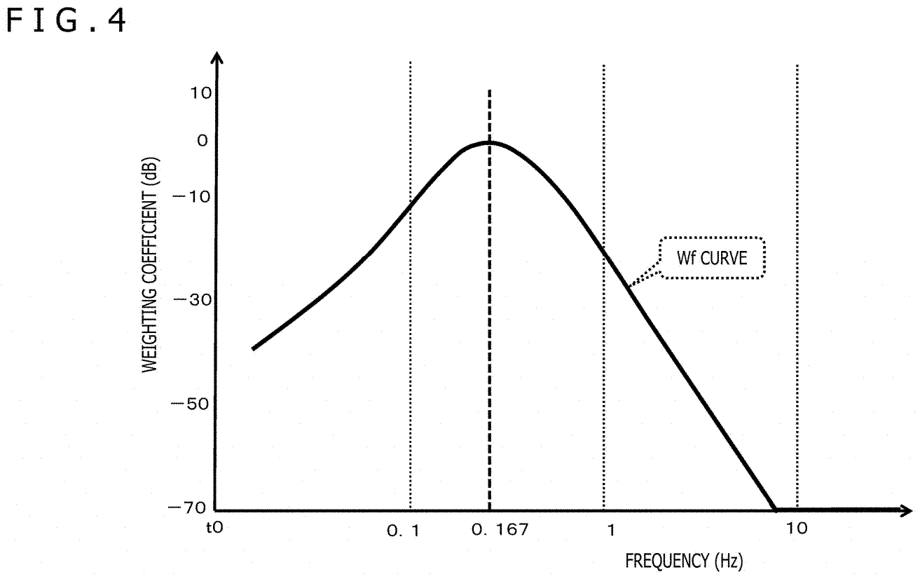

FIG. 4 illustrates a curve corresponding to a Wf filter (Wf curve).

The horizontal axis represents a vibration frequency (Hz) and the vertical axis represents a weighting coefficient (dB).

The Wf curve illustrated in FIG. 4 corresponds to a weight setting curve depending on the magnitudes of sickness levels with respect to low vibration frequencies.

The Wf curve illustrated in FIG. 4 is a curve generated on the basis of a measured result of vomiting ratios at the time various vibrations are produced. The Wf curve indicates that the highest vomiting ratio occurs, i.e., the sickness level is intensive, upon vibrations at a frequency of approximately 0.17 Hz (a period of 6 seconds).

The Wf curve is a weight setting curve where the weight with respect to the vibrations at the frequency of approximately 0.17 Hz (a period of 6 seconds) is highest and weights are set at other frequencies depending on sickness levels (vomiting ratios) corresponding to the frequencies.

As described above, “af” in the above equation a vertical instantaneous acceleration value corrected according to the Wf filter prescribed in ISO2361-1 (1997) illustrated in FIG. 4. The above (Equation 1) represents an arithmetic operation for convolving the Wf curve illustrated in FIG. 4 as a filter with respect to a time-series signal of the vertical component of the acceleration, and calculates a sickness level index value (MSDVz) according to the arithmetic operation.

However, the MSDVz calculated by the above (Equation 1) takes into account only vertical vibrations (oscillations), and the weight setting based on the Wf curve illustrated in FIG. 4 also represents a curve taking into account only vertical vibrations.

In the case of automobiles, not only vertical oscillations, but also horizontal oscillations occur. In other words, vibrations based on horizontal accelerations occur frequently.

According to the present embodiment, it is necessary to take into account sickness levels on automobiles, and it is necessary to take into account not only vibrations in vertical directions, but also vibrations in horizontal directions.

In order to make the MSDVz calculated by the above (Equation 1) effective for vibrations in all directions, “af” in the above (Equation 1) is established as instantaneous acceleration values in all directions.

With respect to the Wf curve, the vertical characteristics illustrated in FIG. 4 are used as they are. Alternatively, a relationship between vibrations in all directions and sickness levels may be newly measured, a new Wf curve effective to the vibrations in all directions may be created, and the Wf curve may be used.

Furthermore, as described above with reference to FIG. 3, the sickness of the operator on the automobile becomes more intensive when the automatic driving mode is executed, and the sickness level becomes more intensive as the automatic driving mode continues.

In the process according to the present disclosure, it is necessary to calculate a sickness level index value depending on the time that has elapsed from the starting time of the automatic driving mode.

Consequently, the equation (Equation 1) for calculating the sickness level index value (MSDVz) based on vertical vibrations prescribed in ISO2361-1 (1997) described above is modified into the following (Equation 2) for calculating a sickness level index value (MSDVz) in the automatic driving mode of the automobile:

### [Math. 2]

MSDV=\sqrt{∫₀^{T}α_{f}²·dt} (Equation 2)

In the above (Equation 2), T represents the time (seconds) that has elapsed after the start of automatic driving, i.e., the time under the influence of the acceleration in the automatic driving mode.

af represents an instantaneous acceleration value corrected according to a Wf filter prescribed in ISO2361-1 (1997). However, unlike the vertical instantaneous acceleration value af in the (Equation 1) described above, the af in the above (Equation 2) represents an instantaneous acceleration value in all directions, not in specific directions.

Incidentally, as described hereinbefore, with respect to the Wf curve used in calculating an instantaneous acceleration value af, the vertical characteristics illustrated in FIG. 4 may be used as they are. Alternatively, a relationship between vibrations in all directions and sickness levels may be newly measured, a new Wf curve effective to the vibrations in all directions may be created, and the Wf curve may be used.

The sickness level index value (MSDV) calculated according to the above (Equation 2) is used as an estimated value of the sickness level of the operator on the automobile 10.

In other words, the sickness level index value (MSDV) calculated according to the above (Equation 2) can be used as the estimated sickness level value (P) illustrated in FIG. 3.

Incidentally, the above (Equation 2) is not restrictive, and other calculating processes may be applied to calculate the estimated sickness level value (P).

For example, the sickness level index value (MSDV) calculated according to the above (Equation 2) may be converted using the following (Equation 3), and a converted value (IR: Illness Rating) calculated according to the (Equation 3) may be used as an estimated sickness level value (P).

### [Math. 3]

IR=α·MSDV=α·\sqrt{∫₀^{T}α_{f}²·dt} (Equation 3)

Alpha in the above (Equation 3) represents a multiplication coefficient.

The multiplication coefficient α is a multiplication coefficient that makes it possible to calculate a scalar value (IR) indicating a sickness level according to the following IR standards.

IR=0=Alright

IR=1=Feeling slightly sick

IR=2=Feeling considerably sick

IR=3=Extremely unpleasant

Alpha in the above (Equation 3) is a multiplication coefficient that is set to calculate a value among the values 0 to 3 indicating the above sickness levels (0: Alright to 3: Extremely unpleasant) from the sickness level index value (MSDV) calculated according to the above (Equation 2), and uses a value such as α=( 1/50) or the like, for example.

The sickness level index value (IR) calculated according to the above (Equation 3) may be used as an estimated value of the sickness level of the operator on the automobile 10.

In other words, the sickness level index value (MSDV) calculated according to the above (Equation 3) can be used as the estimated sickness level value (P) illustrated in FIG. 3.

Note that the warning output standard value (Pv) illustrated in FIG. 3 represents a standard value that defines a timing for outputting a warning for prompting the operator of the automobile that is travelling in the automatic driving mode to change from the automatic driving mode to the manual driving mode.

It is preferable to set the warning output standard value (Pv) to a proper sickness level that allows the operator whose sickness has progressed in the automatic driving mode to return to normal manual driving.

By setting the warning output standard value (Pv) to the sickness level that allows the operator to return to normal manual driving, the operator can start normal manual driving for safe travelling after the warning described with reference to FIG. 2 has been output.

For example, if the warning output standard value (Pv) is set to a high sickness level that does not allow the operator to return to normal manual driving, then after the warning has been output, the operator is too severely sick to start normal manual driving, making it impossible for the automobile to travel safely.

On the other hand, if the warning output standard value (Pv) is set to an excessively low sickness level, then problems arise in that warnings are frequently output, the automatic driving mode continues during a shortened period, and requests for starting manual driving are frequently issued.

Consequently, the warning output standard value (Pv) needs to be set to an optimum value.

Incidentally, the warning output standard value (Pv) can be set according to either one of the following setting processes.

(Setting process 1) A prescribed value is used, and is applied as a common value to all operators, and

(Setting process 2) Inherent values are applied to respective operators.

These two setting processes are possible.

Sickness levels are different among individuals, and there may be cases in which it is not necessarily optimum to use a value common to all operators. Therefore, it is preferable to use a warning output standard value (Pv) inherent in each individual.

A warning output standard value (Pv) inherent in each individual can be calculated by a learning process, for example.

For example, when the automatic driving mode changes to the manual driving mode after the warning has been output, it is determined whether manual driving is taking place normally or not. In case manual driving is taking place normally, the warning output standard value (Pv) is gradually increased.

On the other hand, in case manual driving is not taking place normally when the automatic driving mode changes to the manual driving mode after the warning has been output, the warning output standard value (Pv) is gradually reduced.

By performing such control, a warning output standard value (Pv) that corresponds to each individual (operator) can be set.

The process of determining whether manual driving is taking place normally or not when the automatic driving mode changes to the manual driving mode, and the process of updating the warning output standard value (Pv) on the basis of the determined result are carried out by the data processor 20.

The data processor 20 acquires information about an operation of a handle (steering) and an operation of an accelerator pedal, brake pedal, etc. after manual driving has been started, for example, and determines whether normal manual driving is taking place or not from these pieces of information.

The data processor 20 calculates an optimum value of the warning output standard value (Pv) that corresponds to the operator.

This processing is carried out according to a learning process, for example, and data of the result of the learning process that includes the optimum value of the warning output standard value (Pv) is stored in a storage section (learning data storage section).

The data processor 20 acquires an optimum warning output standard value (Pv) inherent in the operator by referring to the data stored in the storage section (learning data storage section), and outputs the warning illustrated in FIG. 2 in case the sickness level of the operator while the automatic driving mode is being carried out reaches the warning output standard value (Pv).

Incidentally, the above process is not restrictive, and the following (Equation 4) and (Equation 5), for example, may be applied to calculate the estimated sickness level value (P):

P=MSDV−γ·T (Equation 4)

P=IP−γ·T (Equation 5)

The above (Equation 4) and (Equation 5) are equations taking into account the recovery of sickness levels.

MSDV in the above (Equation 4) represents the sickness level index value (MSDV) calculated according to the (Equation 2) described hereinbefore.

IR in the above (Equation 5) represents the converted value (IR: Illness Rating) calculated according to the (Equation 3) described hereinbefore.

Gamma represents a parameter indicative of the level of recovery of sickness levels.

Gamma is affected by individual differences such as people who are more likely to shake off sickness and people who are less likely to shake off sickness, and changes little and can be regarded as a fixed value compared with temporal changes in MSDV, IR.

T represents the exposure time of an acceleration. The estimated sickness level value (P) may be calculated by applying the above (Equation 4) and (Equation 5).

[2. About Specific Configurational Example and Processing Example of Data Processor]

A specific configurational example and processing example of the data processor 20 will be described below.

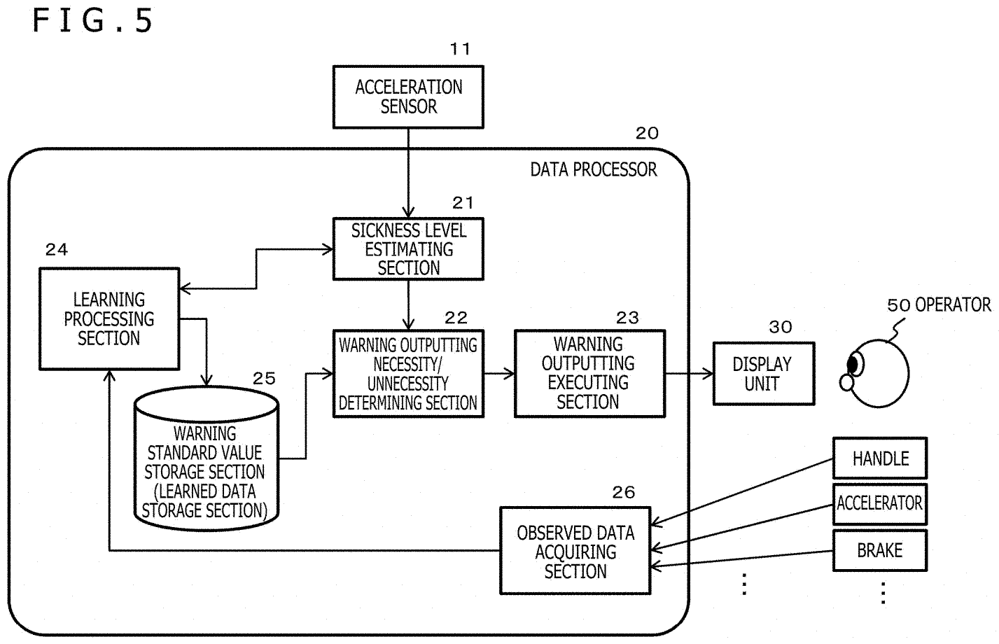

FIG. 5 illustrates an example of the specific configuration of the data processor 20.

As illustrated in FIG. 5, the data processor 20 has a sickness level estimating section 21, a warning outputting necessity/unnecessity determining section 22, a warning outputting executing section 23, a learning processing section 24, a warning standard value storage section (learned data storage section) 25, and an observed data acquiring section 26.

The sickness level estimating section 21 is supplied with acceleration information of the automobile 10 input from the acceleration sensor 11 and estimates a sickness level of the operator.

In other words, the sickness level estimating section 21 calculates an estimated sickness level value (P) described hereinbefore with reference to FIG. 3.

Specifically, the sickness level estimating section 21 calculates a value of either MSDV calculated according to the (Equation 2) described hereinbefore or IR calculated by applying the (Equation 2) and (Equation 3), as an estimated sickness level value (P), using time T that has elapsed from the starting time of the automatic driving mode.

Alternatively, the sickness level estimating section 21 calculates an estimated sickness level value (P) by applying the (Equation 4) or (Equation 5).

In other words, the sickness level estimating section 21 calculates a value of either

MSDV calculated according to the (Equation 2), or

IR calculated by applying the (Equation 2) and (Equation 3),

as a value corresponding to the estimated sickness level value (P) represented by the vertical axis of the graph of FIG. 3.

Alternatively, the sickness level estimating section 21 calculates an estimated sickness level value (P) by applying the (Equation 4) or (Equation 5).

The estimated sickness level value (P) calculated by the sickness level estimating section 21 is input to the warning outputting necessity/unnecessity determining section 22 and the learning processing section 24.

The warning outputting necessity/unnecessity determining section 22 compares the estimated sickness level value (P) input from the sickness level estimating section 21 and the warning output standard value (Pv) stored in the warning standard value storage section (learned data storage section) 25 with each other.

In case the warning outputting necessity/unnecessity determining section 22 decides that the estimated sickness level value (P) input from the sickness level estimating section 21 is equal to or larger than the warning output standard value (Pv), i.e., that the decision formula:

P≥Pv

holds, the warning outputting necessity/unnecessity determining section 22 outputs a request for executing the outputting of a warning to the warning outputting executing section 23.

When the request for executing the outputting of a warning from the warning outputting necessity/unnecessity determining section 22 is input to the warning outputting executing section 23, the warning outputting executing section 23 executes the outputting of a warning on the display unit 30.

A warning display is the display described hereinbefore with reference to FIG. 2, i.e.,

“SICKNESS LEVEL HAS EXCEEDED STANDARD. SWITCH TO MANUAL DRIVING TO PREVENT SICKNESS FROM BECOMING WORSE.”

The warning outputting executing section 23 executes this warning display, prompting the operator to start manual driving.

Note that the warning outputting executing section 23 may output a warning by outputting a warning sound, other than the warning display on the display unit 30.

As described hereinbefore with reference to FIG. 2, the display unit 30 is constructed as a touch panel and can enter inputs according to touches by the user (operator).

As described with reference to FIG. 2, the display unit 30 displays, together with the warning display, the two selection areas representing “SWITCH TO MANUAL DRIVING.” and “CONTINUE AUTOMATIC DRIVING.”

If the user (operator) selects “SWITCH TO MANUAL DRIVING.,” the user (operator) starts manual driving, and it is confirmed that normal manual driving is taking place, then a process of changing from the automatic driving mode to the manual driving mode is carried out.

On the other hand, if the user (operator) selects “CONTINUE AUTOMATIC DRIVING.” and the user (operator) does not start manual driving, then the automatic driving mode is continuously carried out.

The observed data acquiring section 26 acquires operation information of the user (operator).

The observed data acquiring section 26 acquires operation information of the user after the user (operator) has selected “SWITCH TO MANUAL DRIVING.” of the selection input area displayed on the display unit 30 and has started manual driving. For example, the observed data acquiring section 26 acquires operation information of the handle (steering), operation information of the accelerator pedal, brake pedal, etc.

The observed information acquired by the observed data acquiring section 26 is input to the learning processing section 24.

The learning processing section 24 determines whether normal manual driving is taking place or not, immediately after the user (operator) has started manual driving, on the basis of the observed information acquired by the observed data acquiring section 26.

The learning processing section 24 acquires the operation information of the handle (steering), the operation information of the accelerator pedal, brake pedal, etc. after manual driving has started, and determines whether normal manual driving is taking place or not from these pieces of information. Based on the determined information, the learning processing section 24 calculates an optimum value of the warning output standard value (Pv) that corresponds to the operator.

The learning processing section 24 acquires the operation information of the user and carries out a learning process based on the acquired data each time the user (operator) starts manual driving according to the warning display.

In other words, the learning processing section 24 carries out a learning process for calculating an optimum warning output standard value (Pv) inherent in the user (operator). Resultant data of learned data, i.e., the optimum warning output standard value (Pv) inherent in the user (operator) is stored in the warning standard value storage section (learned data storage section) 25.

For example, in case it is confirmed that the user (operator) is performing normal manual driving on the basis of the user operation information input from the observed data acquiring section 26 immediately after the warning has been output, the learning processing section 24 carries out a standard value updating process for gradually increasing the warning output standard value (Pv).

On the other hand, in case it is confirmed that the user (operator) is not performing normal manual driving on the basis of the user operation information input from the observed data acquiring section 26 after the warning has been output, the learning processing section 24 carries out a standard value updating process for gradually reducing the warning output standard value (Pv).

The updated warning output standard value is stored in the warning standard value storage section (learned data storage section) 25.

Incidentally, the warning output standard value (Pv) that is initially stored in the warning standard value storage section (learned data storage section) 25 is a prescribed value. For example, a value common to all operators is stored.

This value will be sequentially updated into values inherent in the respective users (operators) according to a subsequent learning process.

Sickness levels are different among individuals, and there may be cases in which it is not necessarily optimum to use a value common to all operators.

The learning processing section 24 of the data processor 20 calculates an optimum warning output standard value (Pv) inherent in each individual by carrying out a learning process based on the operation information of manual driving immediately after the warning has been output.

By storing optimum warning output standard values (Pv) inherent in users in the warning standard value storage section (learned data storage section) 25 and using them, it is possible to output an optimum warning for each user.

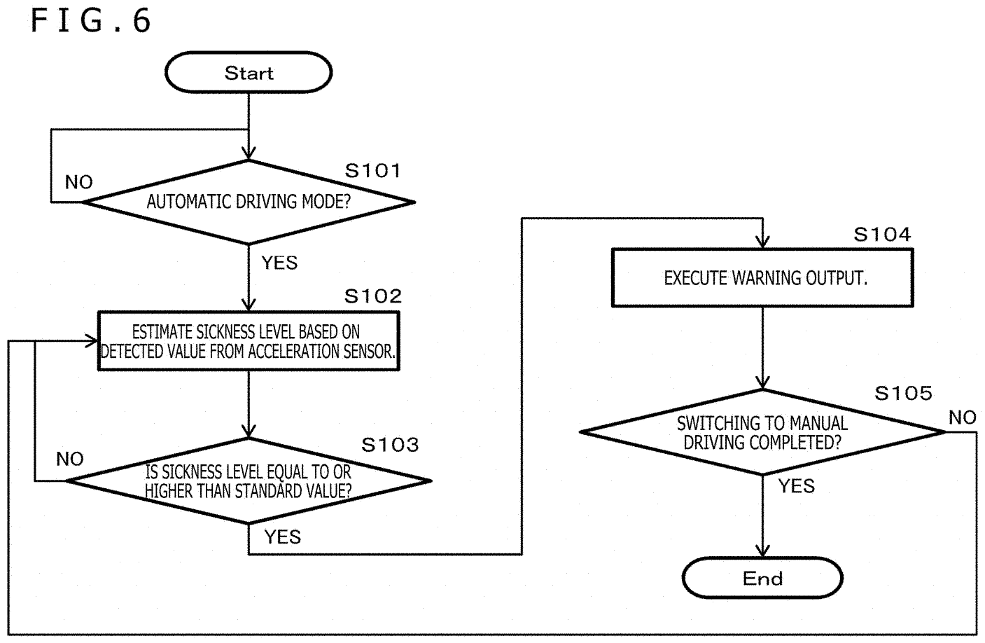

Next, a processing sequence according to the present embodiment will be described below with reference to a flowchart of FIG. 6.

The flowchart illustrated in FIG. 6 is executed by a data processor including a CPU, etc. having a program executing function according to a program stored in the storage section, for example. The data processor 20 illustrated in FIG. 5 reads the program stored in the storage section and carries out a process according to the flowchart illustrated in FIG. 6.

The processing of each of the steps of the flowchart illustrated in FIG. 6 will be described hereinbelow.

(Step S101)

First, the data processor determines whether the automobile is traveling in the automatic driving mode at present or not in step S101.

If the data processor decides that the automobile is traveling in the automatic driving mode, then control goes to step S102.

(Step S102)

If the data processor decides that the automobile is traveling in the automatic driving mode in step S101, then the data processor carries out a sickness level estimating process based on the detected value from the acceleration sensor in step S102.

This process is a process carried out by the sickness level estimating section 21 illustrated in FIG. 5.

The sickness level estimating section 21 is supplied with the acceleration information of the automobile 10 input from the acceleration sensor 11 and estimates a sickness level of the operator.

In other words, the sickness level estimating section 21 calculates an estimated sickness level value (P) described hereinbefore with reference to FIG. 3.

Specifically, the sickness level estimating section 21 calculates a value of either MSDV calculated according to the (Equation 2) described hereinbefore or IR calculated by applying the (Equation 2) and (Equation 3), as an estimated sickness level value (P), using time T that has elapsed from the starting time of the automatic driving mode.

In other words, the sickness level estimating section 21 calculates a value of either

MSDV calculated according to the (Equation 2), or

IR calculated by applying the (Equation 2) and (Equation 3),

as the estimated sickness level value (P).

Alternatively, the sickness level estimating section 21 calculates an estimated sickness level value (P) by applying the (Equation 4) or (Equation 5).

(Step S103)

Next, in step S103, it is determined whether or not the estimated sickness level value (P) calculated by the sickness level estimating section 21 is equal to or larger than the standard value (warning output standard value).

This process is a process carried out by the warning outputting necessity/unnecessity determining section 22 illustrated in FIG. 5.

The warning outputting necessity/unnecessity determining section 22 compares the estimated sickness level value (P) input from the sickness level estimating section 21 and the warning output standard value (Pv) stored in the warning standard value storage section (learned data storage section) 25 with each other.

In case the warning outputting necessity/unnecessity determining section 22 decides that the estimated sickness level value (P) input from the sickness level estimating section 21 is equal to or larger than the warning output standard value (Pv), i.e., that the decision formula:

P≥Pv

holds, control goes to step S104.

In case the above decision formula does not holds, control goes back to step S102, and the sickness level estimating process is continued.

(Step 104)

In case the warning outputting necessity/unnecessity determining section 22 decides that the estimated sickness level value (P) is equal to or larger than the warning output standard value (Pv) in step S103, the outputting of a warning is executed in step S104.

This process is a process carried out by the warning outputting executing section 23 illustrated in FIG. 5.

When a request for executing the outputting of a warning from the warning outputting necessity/unnecessity determining section 22 is input to the warning outputting executing section 23, the warning outputting executing section 23 executes the outputting of a warning on the display unit 30.

A warning display is the display described hereinbefore with reference to FIG. 2, i.e.,

“SICKNESS LEVEL HAS EXCEEDED STANDARD. SWITCH TO MANUAL DRIVING TO PREVENT SICKNESS FROM BECOMING WORSE.”

The warning outputting executing section 23 executes this warning display, prompting the operator to start manual driving.

Note that the warning outputting executing section 23 may output a warning as a warning sound or warning speech, not just the warning display on the display unit 30.

(Step S105)

After the outputting of the warning in step S104, it is confirmed whether switching to manual driving has been completed or not in step S105.

As described with reference to FIG. 2, the display unit 30 displays, together with the warning display, the two selection areas representing “SWITCH TO MANUAL DRIVING.” and “CONTINUE AUTOMATIC DRIVING.”

If the user (operator) selects “SWITCH TO MANUAL DRIVING.,” the user (operator) starts manual driving, and it is confirmed that normal manual driving is taking place, then a process of changing from the automatic driving mode to the manual driving mode is carried out.

On the other hand, if the user (operator) selects “CONTINUE AUTOMATIC DRIVING.” and the user (operator) does not start manual driving, then the automatic driving mode is continuously carried out.

In step S105, in case the user (operator) selects “SWITCH TO MANUAL DRIVING.,” the user (operator) starts manual driving, and it is confirmed that normal manual driving is taking place, then the processing is finished.

On the other hand, in case the user (operator) selects “CONTINUE AUTOMATIC DRIVING.” and the user (operator) does not start manual driving, then the automatic driving mode is continuously carried out. Furthermore, the processing from step S102 on is continued.

In this case, in case the estimated sickness level value (P) of the user continuously exceeds the standard value (Pv), the warning is also continuously or intermittently output.

In case the estimated sickness level value (P) of the user becomes lower than the standard value (Pv), the warning stops being output.

The flow described with reference to FIG. 6 is a flow for explaining a warning outputting process based on the estimated sickness level value (P) of the user (operator) at the time the automatic driving mode is carried out.

The data processer carries out, together with this processing, an updating process for updating the warning output standard value (Pv) according to a learning process in which the operation information of the user after the warning has been output is input.

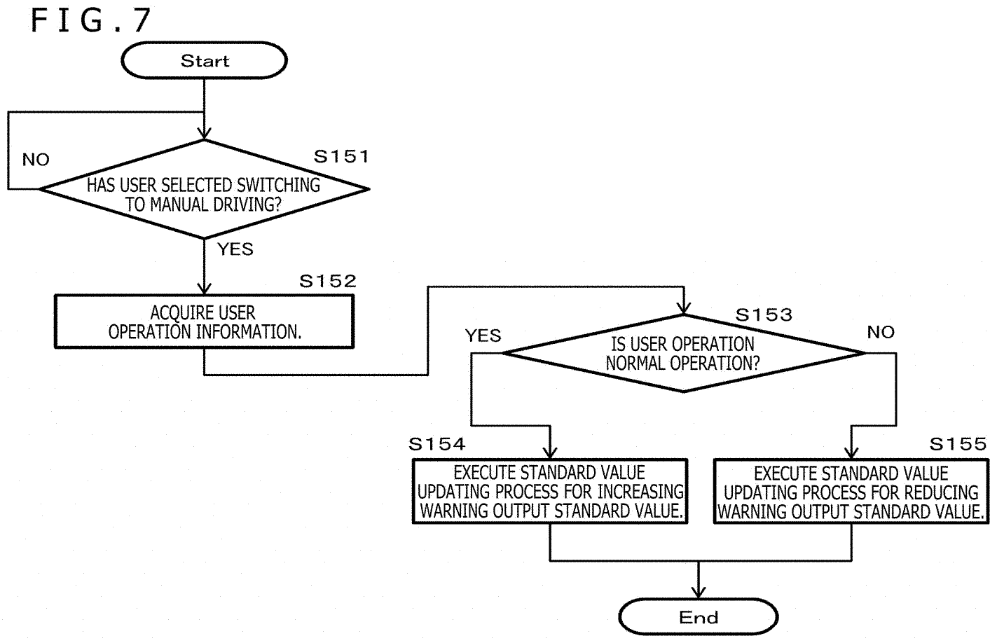

This processing sequence will be described below with reference to a flowchart illustrated in FIG. 7.

As with the flow illustrated in FIG. 6, the flowchart illustrated in FIG. 7 is carried out by a data processor including a CPU, etc. having a program executing function according to a program stored in the storage section, for example. The data processor 20 illustrated in FIG. 5 reads the program stored in the storage section and carries out a process according to the flowchart illustrated in FIG. 7.

The processing of each of the steps of the flowchart illustrated in FIG. 7 will be described hereinbelow.

(Step S151)

First, the data processor determines in step S151 whether the user has selected switching to manual driving or not in response to the warning output.

In other words, the data processor determines whether the user (operator) has selected “SWITCH TO MANUAL DRIVING.” displayed together with the warning output on the display unit 30 illustrated in FIG. 2 or not.

In case the selection is confirmed, control goes to step S152.

(Step S152)

Next, user operation information is acquired in step S152.

This process is carried out by the observed data acquiring section 26.

The observed data acquiring section 26 acquires operation information of the user after the user (operator) has selected “SWITCH TO MANUAL DRIVING.” and has started manual driving. For example, the observed data acquiring section 26 acquires operation information of the handle (steering), operation information of the accelerator pedal, brake pedal, etc.

The observed information acquired by the observed data acquiring section 26 is input to the learning processing section 24.

(Step S153)

Next, it is determined whether the user operation is a normal operation or not in step S153.

This process is a process carried out by the learning processing section 24 illustrated in FIG. 5.

The learning processing section 24 determines whether normal manual driving is taking place or not, immediately after the user (operator) has started manual driving, on the basis of the observed information acquired by the observed data acquiring section 26.

The learning processing section 24 acquires the operation information of the handle (steering), the operation information of the accelerator pedal, brake pedal, etc. after manual driving has started, and determines whether normal manual driving is taking place or not from these pieces of information.

In case the learning processing section 24 decides that normal manual driving is taking place, control goes to step S154.

On the other hand, in case the learning processing section 24 decides that normal manual driving is not taking place, control goes to step S155.

(Step S154)

In case the learning processing section 24 decides in step S153 that normal manual driving is taking place immediately after the user (operator) has started manual driving, control goes to step S154.

In step S154, the learning processing section 24 carries out a standard value updating process for gradually increasing the warning output standard value (Pv).

(Step S155)

In case the learning processing section 24 decides in step S153 that normal manual driving is not taking place immediately after the user (operator) has started manual driving, control goes to step S155.

In step S155, the learning processing section 24 carries out a standard value updating process for gradually reducing the warning output standard value (Pv).

Incidentally, warning output standard values updated in step S154 and step S155 are stored in the warning standard value storage section (learned data storage section) 25.

According to this learning process, the warning output standard value (Pv) stored in the warning standard value storage section (learned data storage section) 25 is sequentially updated into values inherent in the respective users (operators) according to this learning process.

By storing optimum warning output standard values (Pv) inherent in the users in the warning standard value storage section (learned data storage section) 25 and using them, it is possible to output an optimum warning for each user.

[3. About Embodiment Using Biological Sensor]

Next, an embodiment using a biological sensor will be described as embodiment 2 below.

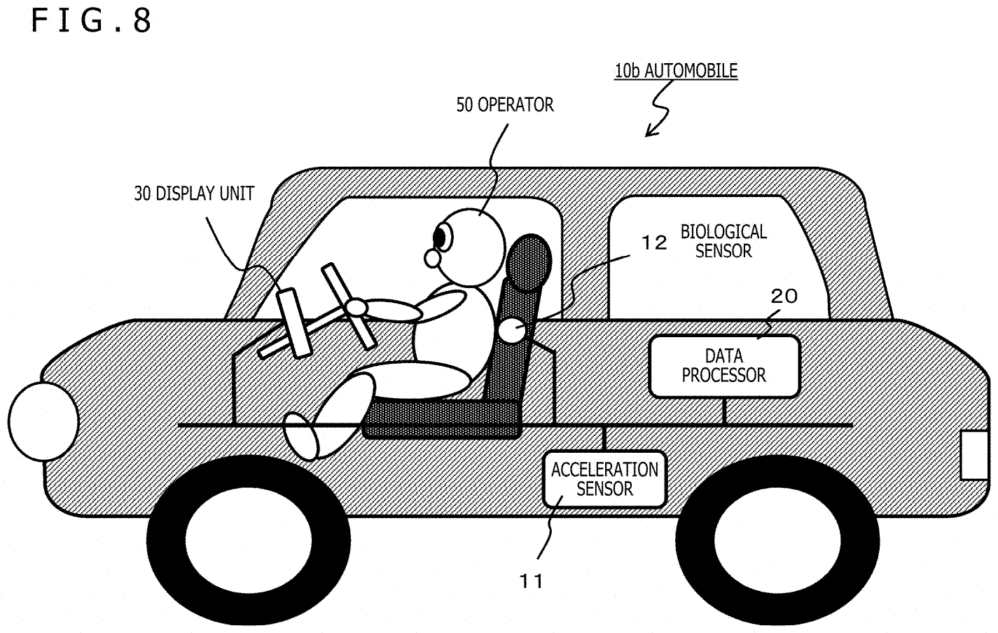

FIG. 8 illustrates an automobile 10b according to the present embodiment 2.

The automobile 10b illustrated in FIG. 8 is of a configuration in which a biological sensor 12 is added to the automobile 10 described hereinbefore with reference to FIG. 1.

Other configurational details are the same as those described with reference to FIG. 1.

As illustrated in FIG. 8, the automobile 10b has an acceleration sensor 11, a biological sensor 12, a data processor 20, and a display unit 30.

The acceleration sensor 11 detects acceleration of the automobile.

The biological sensor 12 is a sensor for acquiring various pieces of biological information of an operator (driver) 50. The biological sensor 12 is not limited to a single sensor, but may include a combination of plural sensors.

For example, the biological sensor 12 is a vibration sensor that detects and processes body movements caused by heart beats of the operator (driver) 50 to measure a heart rate.

Incidentally, the biological sensor 12 is not limited to such a heart rate measuring sensor, but may include the following sensors, for example.

a pulse measuring sensor for the operator (driver) 50,

a camera for capturing a facial image of the operator (driver) 50, and

a head movement measuring sensor for estimating the mood of the operator (driver) 50 on the basis of an analysis of head movements of the operator (driver) 50.

The biological sensor 12 may include either one or a combination of these sensors.

The data processor 20 is supplied with detected information input from the acceleration sensor 11 and the biological sensor 12 and estimates a sickness level of the operator 50 at the time automatic driving is carried out. Furthermore, the data processor 20 outputs a warning (alarm) for prompting the operator 50 to switch from automatic driving to manual driving in case the data processor 20 decides that the sickness level of the operator 50 has reached a prescribed standard value.

The warning (alarm) is executed as a warning that is displayed on the display unit 30 or a warning sound that is output, for example.

The warning to be displayed on the display unit 30 is carried out as the display described hereinbefore with reference to FIG. 2, for example.

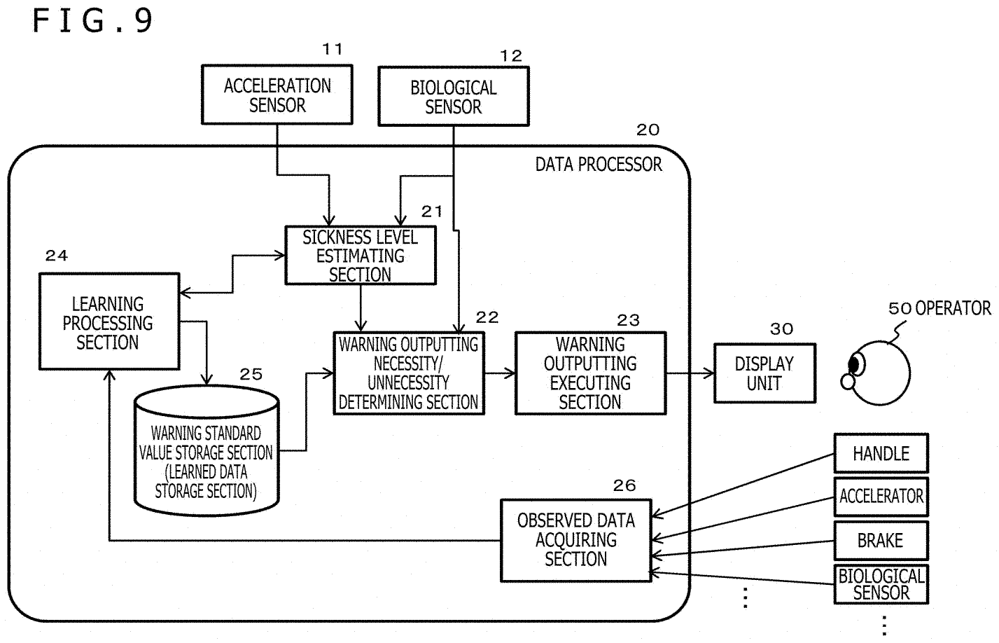

Next, the configuration and processing of the data processor 20 according to the present embodiment will be described below with reference to FIG. 9.

The data processor 20 illustrated in FIG. 9 is of the same configuration as the configuration described hereinbefore with reference to FIG. 5, and has the following components.

The data processor 20 has a sickness level estimating section 21, a warning outputting necessity/unnecessity determining section 22, a warning outputting executing section 23, a learning processing section 24, a warning standard value storage section (learned data storage section) 25, and an observed data acquiring section 26.

However, the sickness level estimating section 21 is supplied with acceleration information of the automobile 10 input from the acceleration sensor 11 and biological information of the operator 50 input from the biological sensor 12, and estimates a sickness level of the operator on the basis of the acceleration information and the biological information.

A sickness level estimating process based on acceleration information is the same as the process described hereinbefore with reference to FIGS. 3 and 4.

Specifically, the sickness level estimating section 21 calculates a value of either MSDV calculated according to the (Equation 2) described hereinbefore or IR calculated by applying the (Equation 2) and (Equation 3), as an estimated sickness level value (P1).

Alternatively, the sickness level estimating section 21 calculates an estimated sickness level value (P1) by applying the (Equation 4) or (Equation 5).

Various processes are carried out as a sickness level estimating process based on biological information detected by the biological sensor 12, depending on the detected information from the biological sensor 12.

In case the biological sensor 12 is a sensor for detecting the heart rate of the operator 50, for example, the sickness level estimating section 21 carries out a sickness level estimating process based on the heart rate of the operator 50. Incidentally, a sickness level estimating process based on the heart rate is described in PTL 3 (Japanese Patent Laid-Open No. Hei 5-245149), for example. A sickness level estimating process may be carried out by applying this existing technology.

Furthermore, an arrangement that uses a sensor for detecting head movements of the operator as the biological sensor 12, for example, carries out a sickness level estimating process on the basis of head movements and information of the operator.

A sickness level estimating process on the basis of head movements and information of the operator is described in PTL 4 (Japanese Patent No. 4882433), for example. A sickness level estimating process may be carried out by applying this existing technology.

In this manner, the sickness level estimating section 21 individually calculates:

an estimated sickness level value (P1) based on the acceleration information; and

an estimated sickness level value (P2) based on the biological information.

Moreover, the sickness level estimating section 21 calculates a final estimated sickness level value (P) of the operator by synthesizing the above two estimated values (P1, P2).

For example, the sickness level estimating section 21 calculates a final estimated sickness level value (P) according to the following weighted additive equation.

P=α·P1+β·P2

The sickness level estimating section 21 calculates a final estimated sickness level value (P) of the operator according to the above equation.

In the above equation, α and β are multiplication coefficients satisfying α+β=1 in the range of 0 to 1, and represent prescribed values.

The final estimated sickness level value (P) of the operator calculated according to the above equation is a value corresponding to the estimated sickness level value (P) represented by the vertical axis of the graph of FIG. 3 described hereinbefore with reference to FIG. 3.

The estimated sickness level value (P) calculated by the sickness level estimating section 21 is input to the warning outputting necessity/unnecessity determining section 22 and the learning processing section 24.

The warning outputting necessity/unnecessity determining section 22 compares the estimated sickness level value (P) input from the sickness level estimating section 21 and the warning output standard value (Pv) stored in the warning standard value storage section (learned data storage section) 25 with each other.

In case the warning outputting necessity/unnecessity determining section 22 decides that the estimated sickness level value (P) input from the sickness level estimating section 21 is equal to or larger than the warning output standard value (Pv), i.e., that the decision formula:

P≥Pv

holds, the warning outputting necessity/unnecessity determining section 22 outputs a request for executing the outputting of a warning to the warning outputting executing section 23.

When the request for executing the outputting of a warning from the warning outputting necessity/unnecessity determining section 22 is input to the warning outputting executing section 23, the warning outputting executing section 23 executes the outputting of a warning on the display unit 30.

A warning display is the display described hereinbefore with reference to FIG. 2, i.e.,

“SICKNESS LEVEL HAS EXCEEDED STANDARD. SWITCH TO MANUAL DRIVING TO PREVENT SICKNESS FROM BECOMING WORSE.”

The warning outputting executing section 23 executes this warning display, prompting the operator to start manual driving.

Note that the warning outputting executing section 23 may output a warning as a warning sound or warning speech, not just the warning display on the display unit 30.

The observed data acquiring section 26 acquires operation information of the user after the user (operator) has selected “SWITCH TO MANUAL DRIVING.” and has started manual driving. For example, the observed data acquiring section 26 acquires operation information of the handle (steering), operation information of the accelerator pedal, brake pedal, etc.

According to the present embodiment, furthermore, the observed data acquiring section 26 acquires biological information from the biological sensor 12.

The user operation information as the observed information acquired by the observed data acquiring section 26 and the biological information are input to the learning processing section 24.

The learning processing section 24 determines whether normal manual driving is taking place or not and whether the sickness level of the user has been lowered or not, immediately after the user (operator) has started manual driving, on the basis of the user operation information and the biological information as the observed information acquired by the observed data acquiring section 26.

The learning processing section 24 acquires the operation information of the handle (steering), the operation information of the accelerator pedal, brake pedal, etc. after manual driving has started, and determines whether normal manual driving is taking place or not from these pieces of information.

Furthermore, the learning processing section 24 acquires the biological information of the user (operator) after manual driving has started, and determines a sickness level of the user (operator).

Based on these pieces of determined information, the learning processing section 24 calculates an optimum value of the warning output standard value (Pv) that corresponds to the operator.

The learning processing section 24 acquires the operation information and the biological information of the user and carries out a learning process based on the acquired data each time the user (operator) starts manual driving according to the warning display.

In other words, the learning processing section 24 carries out a learning process for calculating an optimum warning output standard value (Pv) inherent in the user (operator). Resultant data of learned data, i.e., the optimum warning output standard value (Pv) inherent in the user (operator), is stored in the warning standard value storage section (learned data storage section) 25.

For example, in case it is confirmed that the user (operator) is performing normal manual driving on the basis of the user operation information input from the observed data acquiring section 26 immediately after the warning has been output, the learning processing section 24 carries out a standard value updating process for gradually increasing the warning output standard value (Pv).

Furthermore, the learning processing section 24 acquires the biological information of the user at the time manual driving is started, and decides that the acquired biological information is biological information indicating a low sickness level that allows the user to carry out normal manual driving.

On the other hand, in case it is confirmed that the user (operator) is not performing normal manual driving on the basis of the user operation information input from the observed data acquiring section 26 after the warning has been output, the learning processing section 24 carries out a standard value updating process for gradually reducing the warning output standard value (Pv).

Furthermore, the learning processing section 24 acquires the biological information of the user at the time manual driving is started, and decides that the acquired biological information is biological information indicating a high sickness level that prevents the user from carrying out normal manual driving.

The updated warning output standard value is stored in the warning standard value storage section (learned data storage section) 25.

Furthermore, data about a relationship between the acquired biological information and the sickness level is also stored in the warning standard value storage section (learned data storage section) 25.

Incidentally, the warning output standard value (Pv) that is initially stored in the warning standard value storage section (learned data storage section) 25 is a prescribed value. For example, a value common to all operators is stored.

This value will be sequentially updated into values inherent in the respective users (operators) according to a subsequent learning process.

The data about the biological information and the sickness level that has been stored in the warning standard value storage section (learned data storage section) 25 is referred to in the sickness level estimating process of the sickness level estimating section 21, and used as auxiliary information for performing a more accurate sickness level estimating process.

Sickness levels are different among individuals, and there may be cases in which it is not necessarily optimum to use a value common to all operators.

In the processing according to the present disclosure, an optimum warning output standard value (Pv) inherent in each individual is calculated and made applicable according to the learning process based on the operation information of manual driving immediately after the warning has been output, and data about a relationship between biological information inherent in the user and the sickness level is accumulated on the basis of the biological information at the time manual driving has started immediately after the warning has been output, and is made applicable to a subsequent sickness estimating process.

Moreover, the detected information from the biological sensor 12 may be input to the warning outputting necessity/unnecessity determining section 22, and the warning outputting necessity/unnecessity determining section 22 may directly change the warning output standard value on the basis of the detected information from the biological sensor 12.

For example, a sensor for measuring a stressed state of the operator may be installed as the biological sensor 12, operator stress information acquired by the biological sensor 12 may be input to the warning outputting necessity/unnecessity determining section 22, and in case the warning outputting necessity/unnecessity determining section 22 decides that the stressed state of the operator is high, the warning output standard value may be lowered.

[4. About Embodiment Using Environmental Sensor]

Next, an embodiment using an environmental sensor will be described as embodiment 3 below.

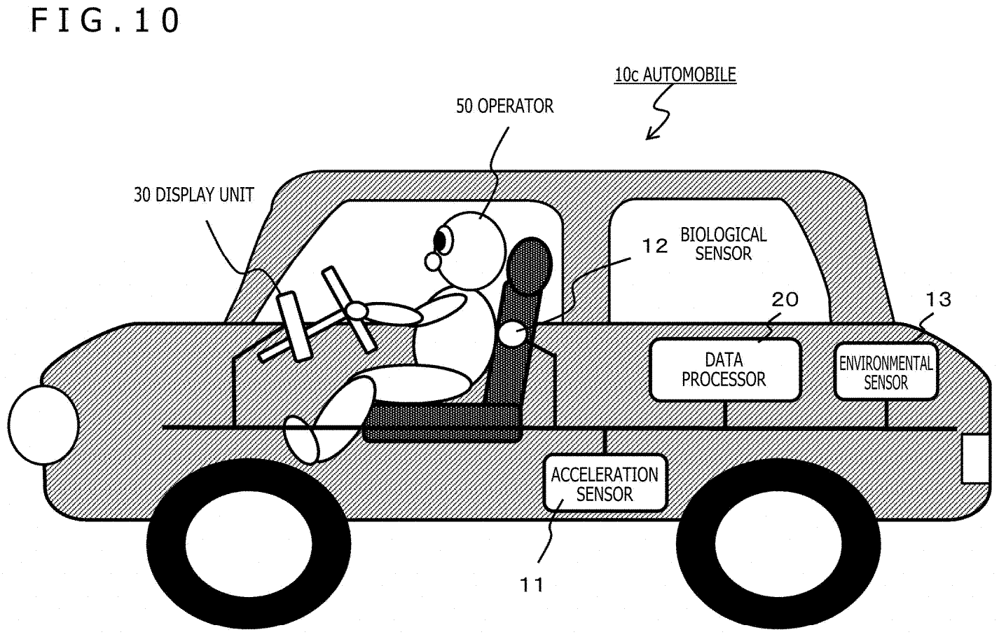

FIG. 10 illustrates an automobile 10c according to the present embodiment.

The automobile 10c illustrated in FIG. 10 is of a configuration in which an environmental sensor 13 is added to the automobile 1b0 described hereinbefore with reference to FIG. 8.

Other configurational details are the same as those described with reference to FIG. 8.

As illustrated in FIG. 10, the automobile 10c has an acceleration sensor 11, a biological sensor 12, an environmental sensor 13, a data processor 20, and a display unit 30.

The acceleration sensor 11 detects acceleration of the automobile.

The biological sensor 12 is a sensor for acquiring various pieces of biological information of an operator (driver) 50. The biological sensor 12 is not limited to a single sensor, but may include a combination of plural sensors.

For example, the biological sensor 12 may include the following sensors, for example.

a sensor for measuring the heart rate of the operator (driver) 50, for example,

a pulse measuring sensor for the operator (driver) 50,

a camera for capturing a facial image of the operator (driver) 50, and

a head movement measuring sensor for estimating the mood of the operator (driver) 50 on the basis of an analysis of head movements of the operator (driver) 50.

The biological sensor 12 may include these sensors, for example.

The environmental sensor 13 is a sensor for acquiring various pieces of environmental information. The environmental sensor 13 is not limited to a single sensor, but may include a combination of plural sensors.

For example, an example of the environmental sensor 13 includes a travel route information acquiring sensor of the automobile 10c.

The travel route information acquiring sensor acquires destination setting information and latitude longitude information from a navigation system. Alternatively, the travel route information acquiring sensor may acquire travel route information using a local dynamic map that represents high-precision map information that is used in automatic driving.

Furthermore, a sensor for acquiring traffic volume information in the peripheral area, a sensor for acquiring schedule information of the operator and companion information of the operator, or the like may be used as the environmental sensor 13.

The data processor 20 is supplied with detected information input from acceleration sensor 11 and the biological sensor 12 and estimates a sickness level of the operator 50 at the time automatic driving is executed. Furthermore, in case the data processor 20 decides that the sickness level of the operator 50 has reached a prescribed warning output standard value (Pv), the data processor 20 outputs a warning (alarm) for prompting the operator 50 to switch from automatic driving to manual driving.

Moreover, the data processor 20 performs a control process for changing the warning output standard value (Pv) on the basis of detected information from the environmental sensor 13.

The warning (alarm) is executed as a warning that is displayed on the display unit 30 or a warning sound that is output, for example.

A warning displayed on the display unit 30 is given as the display described hereinbefore with reference to FIG. 2, for example.

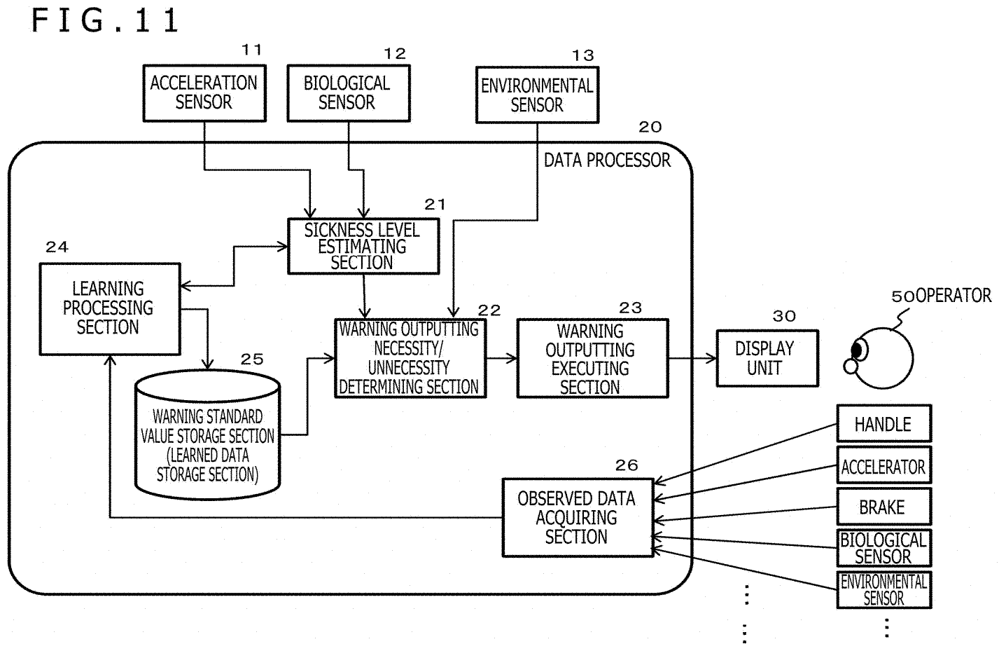

Next, the configuration and processing of the data processor 20 according to the present embodiment will be described below with reference to FIG. 11.

The data processor 20 illustrated in FIG. 11 is of the same configuration as the configuration described hereinbefore with reference to FIG. 5, and has the following components.

The data processor 20 has a sickness level estimating section 21, a warning outputting necessity/unnecessity determining section 22, a warning outputting executing section 23, a learning processing section 24, a warning standard value storage section (learned data storage section) 25, and an observed data acquiring section 26.

However, the sickness level estimating section 21 is supplied with acceleration information of the automobile 10 input from the acceleration sensor 11 and biological information of the operator 50 input from the biological sensor 12.

The sickness level estimating section 21 estimates a sickness level of the operator on the basis of the acceleration information and the biological information.

The warning outputting necessity/unnecessity determining section 22 is supplied with detected information input from the environmental sensor 13 and performs a control process for changing the warning output standard value (Pv).

A sickness level estimating process based on the basis of acceleration information in the sickness level estimating section 21 is the same as the process described hereinbefore with reference to FIGS. 3 and 4.

Specifically, the sickness level estimating section 21 calculates a value of either MSDV calculated according to the (Equation 2) described hereinbefore or IR calculated by applying the (Equation 2) and (Equation 3), as an estimated sickness level value (P1).

Alternatively, the sickness level estimating section 21 calculates an estimated sickness level value (P1) by applying the (Equation 4) or (Equation 5).

A sickness level estimating process based on the biological information detected by the biological sensor 12 is the same as the process described in the preceding embodiment.

For example, a sickness level estimating process based on the heart rate of the operator 50 detected by the biological sensor 12, for example, is carried out.

The sickness level estimating section 21 calculates a final estimated sickness level value (P) of the operator by synthesizing:

an estimated sickness level value (P1) based on the acceleration information; and

an estimated sickness level value (P2) based on the biological information.

For example, the sickness level estimating section 21 calculates a final estimated sickness level value (P) according to the following weighted additive equation.

P=α·P1+βP2

The sickness level estimating section 21 calculates a final estimated sickness level value (P) of the operator according to the above equation.

In the above equation, α and β are multiplication coefficients satisfying α+β=1 in the range of 0 to 1, and represent prescribed values.

The final estimated sickness level value (P) of the operator calculated according to the above equation is a value corresponding to the estimated sickness level value (P) represented by the vertical axis of the graph of FIG. 3 described hereinbefore with reference to FIG. 3.

The estimated sickness level value (P) calculated by the sickness level estimating section 21 is input to the warning outputting necessity/unnecessity determining section 22 and the learning processing section 24.

The warning outputting necessity/unnecessity determining section 22 compares the estimated sickness level value (P) input from the sickness level estimating section 21 and the warning output standard value (Pv) stored in the warning standard value storage section (learned data storage section) 25 with each other.

In case the warning outputting necessity/unnecessity determining section 22 decides that the estimated sickness level value (P) input from the sickness level estimating section 21 is equal to or larger than the warning output standard value (Pv), i.e., that the decision formula:

P≥Pv

holds, the warning outputting necessity/unnecessity determining section 22 outputs a request for executing the outputting of a warning to the warning outputting executing section 23.

Incidentally, the environmental information acquired by the environmental sensor 13 is also input to the warning outputting necessity/unnecessity determining section 22.

For example, in case environmental information indicating that the automobile is traveling on a narrow road or being involved in a traffic jam, the warning outputting necessity/unnecessity determining section 22 applies a standard value (Pv1) smaller than the warning output standard value (Pv) acquired from the warning standard value storage section 25, and compares the standard value (Pv1) with the estimated sickness level value (P) input from the sickness level estimating section 21. In other words, in case the decision formula:

P≥Pv1

holds, the warning outputting necessity/unnecessity determining section 22 outputs a request for executing the outputting of a warning to the warning outputting executing section 23.

Conversely, in case environmental information indicating that the automobile is traveling on a wide road or traveling on a sparse road, the warning outputting necessity/unnecessity determining section 22 applies a standard value (Pv2) larger than the warning output standard value (Pv) acquired from the warning standard value storage section 25, and compares the standard value (Pv2) with the estimated sickness level value (P) input from the sickness level estimating section 21. In other words, in case the decision formula:

P≥Pv2

holds, the warning outputting necessity/unnecessity determining section 22 outputs a request for executing the outputting of a warning to the warning outputting executing section 23.

Furthermore, depending on whether there is a passenger or not, for example, the warning output standard value (Pv) acquired from the warning standard value storage section (learned data storage section) 25 may be changed and the changed warning output standard value (Pv) may be applied.

When the request for executing the outputting of a warning from the warning outputting necessity/unnecessity determining section 22 is input to the warning outputting executing section 23, the warning outputting executing section 23 executes the outputting of a warning on the display unit 30.

A warning display is the display described hereinbefore with reference to FIG. 2, i.e.,

“SICKNESS LEVEL HAS EXCEEDED STANDARD. SWITCH TO MANUAL DRIVING TO PREVENT SICKNESS FROM BECOMING WORSE.”

The warning outputting executing section 23 executes this warning display, prompting the operator to start manual driving.

Note that The warning outputting executing section 23 may output a warning as a warning sound or warning speech, other than the warning display on the display unit 30.

The observed data acquiring section 26 acquires operation information of the user after the user (operator) has selected “SWITCH TO MANUAL DRIVING.” and has started manual driving. For example, the observed data acquiring section 26 acquires operation information of the handle (steering), operation information of the accelerator pedal, brake pedal, etc., and further acquires the biological information from the biological sensor 12.

Furthermore, the observed data acquiring section 26 also acquires environmental information from the environmental sensor 13.

The user operation information as the observed information acquired by the observed data acquiring section 26, the biological information, and the environmental information are input to the learning processing section 24.

According to the present embodiment, the learning processing section 24 performs a learning process to which the environmental information is applied. In case traveling route information up to a destination is acquired as the environmental information, for example, the learning processing section 24 determines whether the distance up to the destination is long or short, and sets the warning output standard value (Pv) to a higher value in case the distance is short. In this manner, even if the sickness level of the operator is high during automatic driving is high, providing the automobile is close to the destination, a threshold value for sickness levels as a notification standard is increased, making a notification less likely to happen.

In case the environmental information includes detected passenger information, the learning processing section 24 decides that the operator is less likely to suffer a sickness, and sets the warning output standard value (Pv) to a higher value.

[5. About Other Embodiments]

Next, other embodiments will be described below.

In the above embodiments, when the sickness level of the operator while the automatic driving mode is being carried out reaches a warning output standard value, a warning is output, prompting the operator to start manual driving. Furthermore, even after the operator has started manual driving, the sickness level estimating process for the operator may be continued, and in case the sickness level is not lowered, the automatic driving mode may be continued without changing to the manual driving mode.

Moreover, after the switching to manual driving in step S105 of the flow illustrated in FIG. 6, for example, the sickness level estimating process for the operator may be continued, and in case the sickness level is not lowered but becomes higher, an emergency vehicle stopping process or a speed reducing process may be carried out.

Furthermore, as described with reference to FIG. 2, the display unit 30 displays, together with the warning display prompting the operator to change to manual driving, the two selection areas representing “SWITCH TO MANUAL DRIVING.” and “CONTINUE AUTOMATIC DRIVING.” Even after the warning has been output, the user (operator) may continue automatic driving by touching “CONTINUE AUTOMATIC DRIVING.” displayed on the display unit 30.

In this fashion, in case the operator continues manual driving even after the warning has been output, the user selection information may be input to the learning processing section 24, and the learning processing section 24 may perform a process of increasing the warning output standard value (Pv).

This is because the fact that the operator continues manual driving even after the warning has been output leads the learning processing section 24 to decide that the operator is aware that its sickness level is low.

In other words, the learning processing section 24 decides that the warning notification standard is lower than the subjective standard of the operator and increases the warning output standard value (Pv). This control is able to reduce wasteful warning notifications to the operator.

According to the embodiments described above furthermore, the operator is notified of warnings mainly by way of display on the display unit 30. However, the operator may be notified of warnings by way of speech.

According to the embodiments described above moreover, there has been described a user interface configuration in which the display unit 30 is constructed as a touch panel and the user can enter inputs by touching the two selection areas representing “SWITCH TO MANUAL DRIVING.” and “CONTINUE AUTOMATIC DRIVING.”

A user interface is not limited to the touch panel system, but may use other systems. For example, there may be used various interface configurations including the inputting of speech through a microphone, the recognition of gestures through a camera, and the confirmation of a start of manual driving triggered when the handle or pedal starts to be operated.

Furthermore, in case automatic driving is continued, the heart rate measured by the biological sensor 12 or a heart rate variation feature quantity such as LF/HF derived from the heart rate may be input to the learning processing section 24, enabling the learning processing section 24 to update the warning output standard value (Pv).

According to the above embodiments, moreover, the sickness level estimating section 21 is configured to estimate a sickness level of the operator using the detected information from the acceleration sensor 11 or the detected information from the biological sensor 12.

In addition, a sickness level may be estimated on the basis of a self-assessment report from the operator.

For example, the operator may enter an input (self-assessment report) indicating that its sickness level has increased by way of speech, a button, a touch interface, or the like, for example.

According to the above embodiments, furthermore, all the processing sections are included within the automobile. However, some of the processing sections may be placed outside of the automobile.

For example, some of the processing functions may be incorporated in a smartphone or a wearable device that can be used by the operator or in an external server. For example, the automobile and the external server may communicate with each other, and some of the processing may be executed by the external server.

In addition, a wearable device worn by the operator may measure the pulse of the operator and send the measured pulse to a smartphone through Bluetooth (registered trademark). The smart phone may estimate a sickness level from a time-depending change of the pulse, and compare the sickness level with the warning output standard value (Pv). In case the sickness level becomes equal to or larger than the warning output standard value (Pv), the smart phone may notify the operator of a warning by way of speech and flash light.

For example, it is possible to incorporate a configuration using such an external device.

Particularly, the processing by the learning processing section, which poses a large processing load, may be executed by an external server thereby to reduce the processing load on the automobile.

[6. About Configurational Example of Vehicle Control System in Mobile Apparatus]

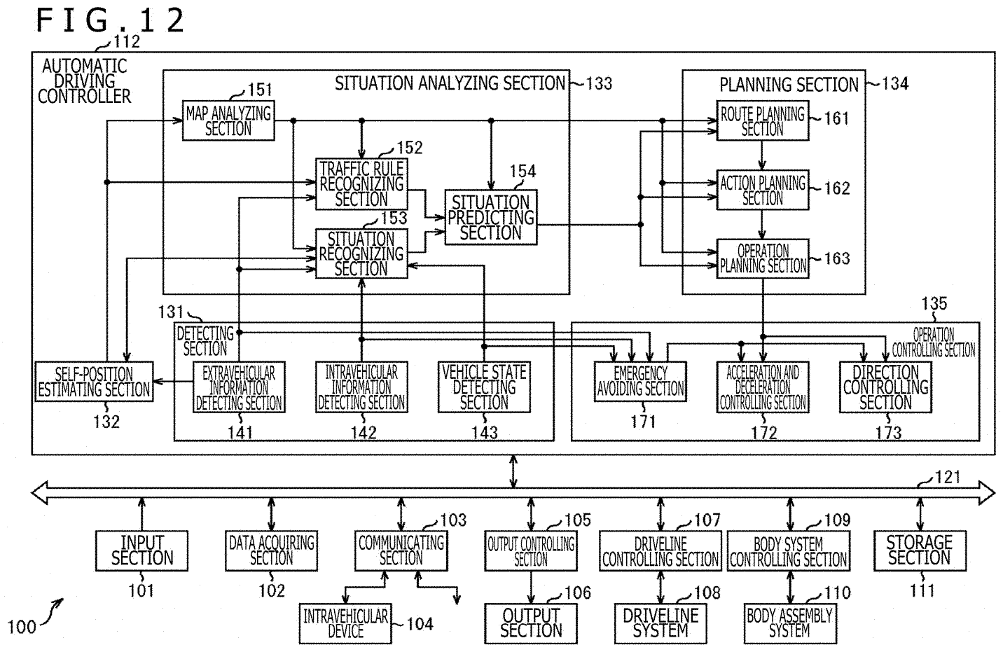

Next, an example of the configuration of a vehicle control system in a mobile apparatus will be described below with reference to FIG. 12.

FIG. 12 is a diagram illustrating an example of the configuration of a vehicle control system 100 installed in an automobile 10 as a mobile apparatus that performs the processing described above.

By the way, in case the vehicle incorporating the vehicle control system 100 is to be distinguished from other vehicles, the vehicle will hereinafter be referred to as an own car or own vehicle.

The vehicle control system 100 includes an input section 101, a data acquiring section 102, a communicating section 103, an intravehicular device 104, an output controlling section 105, an output section 106, a driveline controlling section 107, a driveline system 108, a body system control section 109, a body assembly system 110, a storage section 111, and an automatic driving controller 112. The input section 101, the data acquiring section 102, the communicating section 103, the output controlling section 105, the driveline controlling section 107, the body system control section 109, the storage section 111, and the automatic driving controller 112 are interconnected by a communication network 121. The communication network 121 includes a vehicle-mounted communication network, buses, etc. according to optional standards such as CAN (Controller Area Network), LIN (Local Interconnect Network), LAN (Local Area Network), FlexRay (registered trademark), or the like, for example. Note that the components of the vehicle control system 100 may be directly interconnect, not via the communication network 121.

Incidentally, in case the components of the vehicle control system 100 communicate via the communication network 121, the communication network 121 will be omitted from description. For example, in case the input section 101 and the automatic driving controller 112 communicate with each other via the communication network 121, the input section 101 and the automatic driving controller 112 will be described simply as communicating with each other.

The input section 101 includes a device to be used by a vehicle occupant to enter various data, instructions, etc. For example, the input section 101 includes an operation device such as a touch panel, buttons, a microphone, switches, levers, etc., and an operation device capable of entering inputs via a method other than manual operation, such as speech, gestures, etc. Furthermore, the input section 101 may be a remote control device that uses infrared rays or other radio waves, or an external connection device such as a mobile device, a wearable device, or the like that is compatible operatively with the vehicle control system 100. The input section 101 generates input signals based on data, instructions, etc. entered by the vehicle occupant and supplies the generated input signals to the components of the vehicle control system 100.

The data acquiring section 102 includes various sensors, etc. that acquire data to be used in the processing by the vehicle control system 100, and supplies the acquired data to the components of the vehicle control system 100.

For example, the data acquiring section 102 includes various sensors for detecting the state of the own car, etc. Specifically, for example, the data acquiring section 102 includes a gyrosensor, an acceleration sensor, an inertial measurement unit (IMU), sensors for detecting an operation quantity of an accelerator pedal, an operation quantity of a brake pedal, a steering angle of a steering wheel, an engine rotational speed, a motor rotational speed, a wheel rotational speed, etc.

Furthermore, for example, the data acquiring section 102 includes various sensors for detecting information about the exterior of the own car. Specifically, the data acquiring section 102 includes image capturing devices such as a ToF (Time Of Flight) camera, a visible light camera, a stereo camera, a monocular camera, a (far) infrared camera, and other cameras. Furthermore, for example, the data acquiring section 102 includes an environmental sensor for detecting weathers, climates, or the like, and a peripheral information sensor for detecting objects in the periphery of the own car. The environmental sensor includes, for example, a raindrop sensor, a fog sensor, sunlight sensor, a snow sensor, etc. The peripheral information sensor includes, for example, an ultrasonic sensor, a radar, a LiDAR (Light Detection and Ranging, Laser Imaging Detection and Ranging), a sonar, etc.

Furthermore, for example, the data acquiring section 102 includes various sensors for detecting the present position of the own car. Specifically, for example, the data acquiring section 102 includes GNSS (Global Navigation Satellite System) receiver or the like receiving GNSS signals from GNSS satellites.

Furthermore, for example, the data acquiring section 102 includes various sensors for detecting intravehicular information. Specifically, for example, the data acquiring section 102 includes an image capturing device for capturing an image of the operator, a biological sensor for detecting biological information of the operator, a microphone for picking up intravehicular speech, etc. The biological sensor is disposed on a seat surface, a steering wheel, or the like, and detects biological information of a vehicle occupant seated on a seat or biological information of the operator who is gripping the steering wheel.

The communicating section 103 communicates with the intravehicular device 104 and various devices, servers, base stations, etc. outside of the vehicle, sends data supplied from the components of the vehicle control system 100, and supplies received data to the components of the vehicle control system 100. Note that a communication protocol supported by the communicating section 103 is not limited to any particular communication protocol, and the communicating section 103 can support a plurality types of communication protocols.

For example, the communicating section 103 communicates with the intravehicular device 104 via a wireless link according to a wireless LAN, Bluetooth (registered trademark), NFC (Near Field Communication), WUSB (Wireless USB), or the like. Furthermore, for example, the communicating section 103 communicates with the intravehicular device 104 via a wired link through a connection terminal, not depicted, (and a cable, if necessary) according to USB (Universal Serial Bus), HDMI (registered trademark) (High-Definition Multimedia Interface), MHL (Mobile High-definition Link), or the like.

Furthermore, for example, the communicating section 103 communicates with a device (e.g., an application server or a control server) existing on an external network (e.g., the Internet, a cloud network, or a network inherent in a company) via a base station or an access point. Moreover, for example, the communicating section 103 communicates with a terminal (e.g., a pedestrian or shop terminal or an MTC (Machine Type Communication) terminal) existing in the vicinity of the own car, using the P2P (Peer To Peer) technology. Moreover, for example, the communicating section 103 performs V2X communication such as vehicle to vehicle communication, vehicle to infrastructure communication, vehicle to home communication, vehicle to pedestrian communication, etc. In addition, for example, the communicating section 103 includes a beacon receiver and receives radio waves or electromagnetic waves sent from a wireless station installed on a road to acquire the present position, traffic jams, traffic restrictions, required times, etc.

The intravehicular device 104 includes, for example, a mobile device or wearable device that is owned by a vehicle occupant, an information device carried into or installed in the own car, a navigation device that searches for a route up to an optional destination, etc.

The output controlling section 105 controls the outputting of various pieces of information to an occupant of the own car or to the outside of the vehicle. For example, the output controlling section 105 generates an output signal including at least one of visual information (e.g., image data) or aural information (e.g., speech data), and supplies the generated output signal to the output section 106, thereby controlling the outputting of the visual information and the aural information from the output section 106. Specifically, for example, the output controlling section 105 synthesizes image data captured by the different image capturing devices of the data acquiring section 102 to generate a bird's eye image, a panoramic image, or the like, and supplies an output signal including the generated image to the output section 106. Furthermore, for example, the output controlling section 105 generates sound data including a warning sound, a warning message, or the like with respect to a danger such as a collision, a contact, an entry into a dangerous zone, or the like, and supplies an output signal including the generated sound data to the output section 106.

The output section 106 includes a device capable of outputting visual information or aural information to an occupant of the own car or to the outside of the vehicle. For example, the output section 106 includes a display device, an instrument panel, an audio speaker, headphones, a wearable device such as a spectacle-type display or the like worn by the occupant, a projector, a lamp, or the like. The display device included in the output section 106 may be a device for displaying visual information within the field of vision of the operator, such as a head-up display, a transmissive-type display, a device having an AR (Augmental Reality) display function, or the like, other than a device having an ordinary display.

The driveline controlling section 107 generates various control signals and supplies the generated control signals to the driveline system 108 thereby to control the driveline system 108. Furthermore, when necessary, the driveline controlling section 107 supplies control signals to the components other than the driveline system 108 to indicate a controlled state of the driveline system 108.

The driveline system 108 includes various devices relative to the driveline of the own car. For example, the driveline system 108 includes a drive power generating device for generating drive power such as an internal combustion engine, a drive motor, or the like, a drive power transmitting mechanism for transmitting drive power to wheels, a steering mechanism for adjusting the steering angle, a braking device for generating braking forces, an ABS (Antilock Brake System), an ESC (Electronic Stability Control), an electric power steering device, etc.

The body system controlling section 109 generates various control signals and supplies the generated control signals to the body assembly system 110, and control the body assembly system 110. Moreover, when necessary, the body system controlling section 109 supplies control signals to components other than the body assembly system 110 to indicate a controlled state of the body assembly system 110.

The body assembly system 110 includes various devices of a body assembly of the vehicle body. For example, the body assembly system 110 includes a keyless entry system, a smart key system, a power window device, a power seat, a steering wheel, an air conditioner, and various lamps (e.g., headlamps, back lamps, brake lamps, blinkers, fog lamps, etc.).

The storage section 111 includes a magnetic storage device such as a ROM (Read Only Memory), a RAM (Random Access Memory), an HDD (Hard Disc Drive), etc., a semiconductor storage device, an optical storage device, a magnetooptical storage device, etc. The storage section 111 stores various programs, data, etc. used by the components of the vehicle control system 100. For example, the storage section 111 stores map data of a three-dimensional high-precision map such as a dynamic map or the like, a global map lower in precision than the high-precision map and covering a wider area, a local map including information of the periphery of the own car, etc.

The automatic driving controller 112 performs control about automatic driving such as autonomous traveling, driving assistance, etc. Specifically, for example, the automatic driving controller 112 performs coordinated control for realizing functions of an ADAS (Advanced Driver Assistance System) including collision avoidance or shock softening of the own car, following travelling based on a vehicle to vehicle distance, traveling at a maintained vehicle speed, collision warning for the own car, a lane departure warning for the own car, etc. Moreover, for example, the automatic driving controller 112 performs coordinated control for automatic driving to make the vehicle travel autonomously independently of operator's operation, etc. The automatic driving controller 112 includes a detecting section 131, a self-position estimating section 132, a situation analyzing section 133, a planning section 134, and an operation controlling section 135.

The detecting section 131 detects various pieces of information required for the control of automatic driving. The detecting section 131 includes an extravehicular information detecting section 141, an intravehicular information detecting section 142, and a vehicle state detecting section 143.

The extravehicular information detecting section 141 performs a detecting process for detecting information outside of the own car on the basis of data or signals from the components of the vehicle control system 100. For example, the extravehicular information detecting section 141 performs a detecting process, a recognizing process, and a following process for detecting, recognizing, and following objects in the periphery of the own car, and a detecting process for detecting the distances up to the objects. The objects to be detected include, for example, vehicles, human beings, obstacles, structures, roads, traffic signals, traffic signs, road markings, etc. Furthermore, for example, the extravehicular information detecting section 141 performs a detecting process for detecting environments in the periphery of the own car. The environments in the periphery to be detected include, for example, weather, air temperature, humidity, lightness, road state, etc. The extravehicular information detecting section 141 supplies data representing the results of the detecting processes to the self-position estimating section 132, a map analyzing section 151, a traffic rule recognizing section 152, and a situation recognizing section 153 of the situation analyzing section 133, an emergency avoiding section 171 of the operation controlling section 135, etc.

The intravehicular information detecting section 142 performs a detecting process for detecting intravehicular information on the basis of data or signals from the components of the vehicle control system 100. For example, the intravehicular information detecting section 142 performs an authenticating process and a recognizing process for authenticating and recognizing the operator, a detecting process for detecting states of the operator, a detecting process for detecting a vehicle occupant, a detecting process for detecting environments in the vehicle, etc. The states of the operator to be detected include, for example, body condition, arousal, concentration, fatigue, direction of line of sight, etc. The environments in the vehicle to be detected include, for example, air temperature, humidity, lightness, smell, etc. The intravehicular information detecting section 142 supplies data representing the results of the detecting processes to the situation recognizing section 153 of the situation analyzing section 133, the emergency avoiding section 171 of the operation controlling section 135, etc.

The vehicle state detecting section 143 performs a detecting process for detecting states of the own car on the basis of data or signals from the components of the vehicle control system 100. The states of the own car to be detected include, for example, speeds, accelerations, steering angles, presence or absence and contents of malfunctions, states of driving operations, positions and tilts of power seats, states of door locks, states of other vehicle-mounted devices, etc. The vehicle state detecting section 143 supplies data representing the results of the detecting processes to the situation recognizing section 153 of the situation analyzing section 133, the emergency avoiding section 171 of the operation controlling section 135, etc.

The self-position estimating section 132 performs an estimating process for estimating the position, posture, etc. of the own car on the basis of data or signals from the components of the vehicle control system 100 such as the extravehicular information detecting section 141, the situation recognizing section 153 of the situation analyzing section 133, etc. Furthermore, when necessary, the self-position estimating section 132 generates a local map used to estimate an own position (hereinafter referred to as an own position estimating map). The own position estimating map is a high-precision map using a technology such as SLAM (Simultaneous Localization and Mapping) or the like. The self-position estimating section 132 supplies data representing the results of the estimating process to the map analyzing section 151 of the situation recognizing section 153, the traffic rule recognizing section 152, the situation recognizing section 153, etc. Moreover, the self-position estimating section 132 stores the own position estimating map in the storage section 111.

The situation analyzing section 133 performs an analyzing process for analyzing the situation of the own car and the periphery thereof. The situation analyzing section 133 includes a map analyzing section 151, a traffic rule recognizing section 152, a situation recognizing section 153, and a situation predicting section 154.

The map analyzing section 151 performs an analyzing process for analyzing various maps stored in the storage section 111, using, when necessary, data or signals from the components of the vehicle control system 100 such as the self-position estimating section 132, the extravehicular information detecting section 141, etc., and constructs a map including information necessary to process automatic driving. The map analyzing section 151 supplies the constructed map to the traffic rule recognizing section 152, the situation recognizing section 153, the situation predicting section 154, and a route planning section 161, an action planning section 162, and an operation planning section 163 of the planning section 134, etc.

The traffic rule recognizing section 152 performs a recognizing process for recognizing traffic rules around the own car on the basis of data or signals from the components of the vehicle control system 100 such as the self-position estimating section 132, the extravehicular information detecting section 141, the map analyzing section 151, etc. The recognizing process allows the positions and states of signals around the own vehicle, the contents of traffic rules around the own vehicle, lanes that can be traveled, etc., for example, to be recognized. The traffic rule recognizing section 152 supplies data representing the results of the recognizing process to the situation predicting section 154, etc.

The situation recognizing section 153 performs a recognizing process for recognizing situations relative to the own car on the basis of data or signals from the components of the vehicle control system 100 such as the self-position estimating section 132, the extravehicular information detecting section 141, the intravehicular information detecting section 142, vehicle state detecting section 143, the map analyzing section 151, etc. For example, the situation recognizing section 153 performs a recognizing process for recognizing situations of the own car, situations of the periphery of the own car, situations of the operator of the own car, etc. Furthermore, when necessary, the situation recognizing section 153 generates a local map used to recognize the situations of the periphery of the own car (hereinafter referred to as a situation recognizing map). The situation recognizing map may be an occupancy grid map, for example.

The situations of the own car to be recognized include, for example, the position, posture, movement (e.g., speeds, accelerations, moving directions, etc.) of the own car, presence or absence and contents of malfunctions, etc. The situations of the periphery of the own car to be recognized include, for example, kinds and positions of still objects in the periphery, kinds, positions, and movements (e.g., speeds, accelerations, moving directions, etc.) of mobile bodies in the periphery, structures of roads and states of road surfaces in the periphery, weather, air temperature, humidity, lightness, etc. in the periphery, etc. The states of the operator to be recognized include, for example, body condition, arousal, concentration, fatigue, movement of line of sight, driving operations, etc.

The situation recognizing section 153 supplies data representing the results of the recognizing process (including the situation recognizing map, if necessary) to the self-position estimating section 132, the situation predicting section 154, etc. The situation recognizing section 153 stores the situation recognizing map in the storage section 111.

The situation predicting section 154 performs a predicting process for predicting situations relative to the own car on the basis of data or signals from the components of the vehicle control system 100 such as the map analyzing section 151, the traffic rule recognizing section 152, the situation recognizing section 153, etc. For example, the situation predicting section 154 performs a predicting process for predicting situations of the own car, situations of the periphery of the own car, situations of the operator, etc.

The situations of the own car to be predicted include, for example, the behavior of the own car, the occurrence of malfunctions, traveled distances, etc. The situations of the periphery of the own car to be predicted include, for example, the behavior of mobile bodies in the periphery of the own care, changes in the state of signals, changes in the environment such as weather, etc. The situations of the operator to be predicted include, for example, the behavior and body condition of the operator, etc.

The situation predicting section 154 supplies data representing the results of the predicting process, together with the data from the traffic rule recognizing section 152 and the situation recognizing section 153, to the route planning section 161, the action planning section 162, and the operation planning section 163 of the planning section 134, etc.

The route planning section 161 plans a route up to a destination on the basis of data or signals from the components of the vehicle control system 100 such as the map analyzing section 151, the situation predicting section 154, etc. For example, the route planning section 161 plans a designated route from the present position up to a destination on the basis of the global map. Moreover, for example, the route planning section 161 changes the route appropriately on the basis of situations including traffic jams, accidents, traffic restrictions, constructions, etc. and the body condition of the operator, etc. The route planning section 161 supplies data representing the planned route to the action planning section 162, etc.

The action planning section 162 plans an action of the own car for safely travelling on the route planned by the route planning section 161 within a planned time, on the basis of data or signals from the components of the vehicle control system 100 such as the map analyzing section 151, the situation predicting section 154, etc. For example, the action planning section 162 plans starts, stops, travelling directions (e.g., forward movement, backward movement, left turns, right turns, changes of direction, etc.), travel lanes, travel speeds, overtaking, etc. The action planning section 162 supplies data representing the planned action of the own car to the operation planning section 163, etc.

The operation planning section 163 plans operations of the own car to realize the action planned by the action planning section 162, on the basis of data or signals from the components of the vehicle control system 100 such as the map analyzing section 151, the situation predicting section 154, etc. For example, the operation planning section 163 plans accelerations, decelerations, travel tracks, etc. The operation planning section 163 supplies data representing the planned operation of the own car to an acceleration and deceleration controlling section 172, a direction controlling section 173, etc. of the operation controlling section 135.

The operation controlling section 135 controls operations of the own car. The operation controlling section 135 includes an emergency avoiding section 171, an acceleration and deceleration controlling section 172, and a direction controlling section 173.

The emergency avoiding section 171 performs a detecting process for detecting collisions, contacts, entries into dangerous zones, abnormalities of the operator, malfunctions of the vehicle, etc., on the basis of the detected results from the extravehicular information detecting section 141, the intravehicular information detecting section 142, and the vehicle state detecting section 143. In case the emergency avoiding section 171 detects an occurrence of emergency, it plans an operation of the own vehicle to avoid the emergency, such as a sudden stop, a sudden turn, etc. The emergency avoiding section 171 supplies data representing the planned operation of the own vehicle to the acceleration and deceleration controlling section 172, the direction controlling section 173, etc.

The acceleration and deceleration controlling section 172 performs an acceleration and deceleration controlling process for realizing the operation of the own car planned by the operation planning section 163 or the emergency avoiding section 171. For example, the acceleration and deceleration controlling section 172 calculates a control target value for the drive power generating device or the braking device for realizing the planned acceleration, deceleration, or sudden stop, and supplies a control command representing the calculated control target value to the driveline controlling section 107.

The direction controlling section 173 performs a direction controlling process for realizing the operation of the own car planned by the operation planning section 163 or the emergency avoiding section 171. For example, the direction controlling section 173 calculates a control target value for the steering mechanism for realizing the travel track or quick turn planned by the operation planning section 163 or the emergency avoiding section 171, and supplies the a control command representing the calculated control target value to the driveline controlling section 107.

[7. About Configurational Example of Information Processing Apparatus]

FIG. 12 illustrates the configuration of the vehicle control system 100 as an example of a mobile body control system that can be installed in a mobile apparatus that performs the processing described above. The processing according to the embodiments described above can be performed by inputting detected information from various sensors to an information processing apparatus such as a PC or the like.

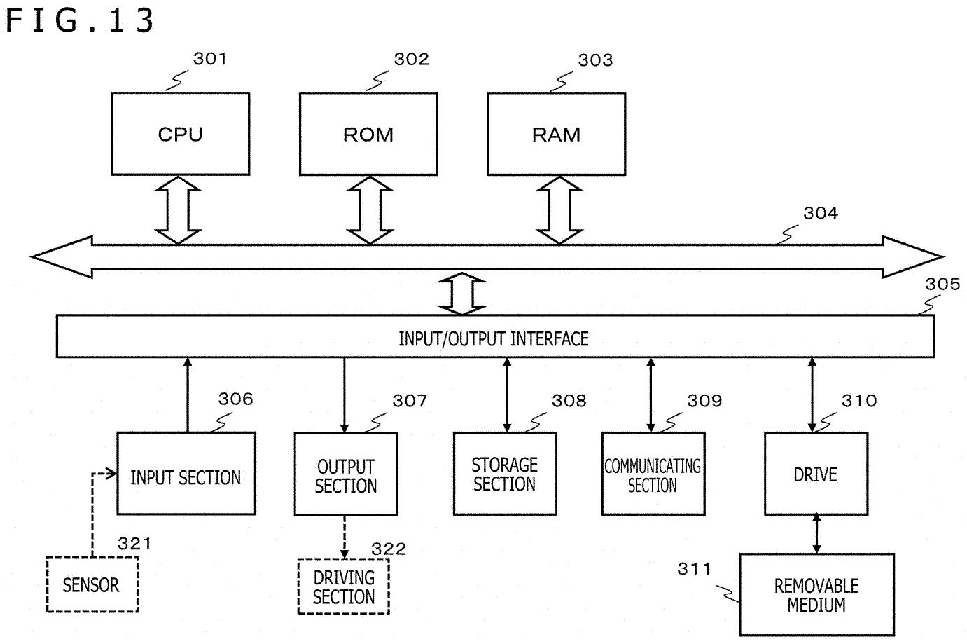

A specific hardware configuration of the information processing apparatus in this case will be described below with reference to FIG. 13.

FIG. 13 is a diagram illustrating an example of the configuration of the hardware of an information processing apparatus such as a general PC or the like.

A CPU (Central Processing Unit) 301 functions as a data processor for executing various processes according to programs stored in a ROM (Read Only Memory) 302 or a storage section 308. For example, the CPU 301 executes processes according to sequences described in the above embodiments. The programs executed by the CPU 301, data, etc. are stored in a RAM (Random Access Memory) 303. The CPU 301, the ROM 302, and the RAM 303 are interconnected by a bus 304.

The CPU 301 is connected to an input/output interface 305 by the bus 304. An input section 306 including various switches, a keyboard, a touch panel, a mouse, a microphone, and a situation data acquiring section including sensors, a camera, a GPS, etc., and an output section 307 including a display, a speaker, etc. are connected to the input/output interface 305.

By the way, input information from a sensor 321 is also input to the input section 306.

Furthermore, the output section 307 also outputs drive information to a driving section 322 of the mobile apparatus.

The CPU 301 is supplied with commands, situation data, etc. input from the input section 306, executes various processes, and outputs the results of the processes to the output section 307, for example.

The storage section 308 that is connected to the input/output interface 305 includes a hard disk or the like, for example, and stores the programs executed by the CPU 301 and various data. A communicating section 309 functions as a transmitter/receiver for data communication through a network such as the Internet or a local area network, and communicates with external apparatus.

A drive 310 that is connected to the input/output interface 305 drives a removable medium 311 such as a magnetic disk, an optical disk, a magnetooptical disk, or a semiconductor memory such as a memory card or the like, and carries out recording or reading of data.

[8. Summarization of Configurations According to Present Disclosure]

The embodiments of the present disclosure have been described in detail above with reference to the particular embodiments. However, it is obvious for those skilled in the art to be able to make alterations and substitutions to the embodiments without departing from the scope of the present disclosure. In other words, the present invention has been disclosed by way of illustrative example, and should not be construed as restrictive. The scope of claims should be taken into account for determining the scope of the present disclosure.

Note that the technology disclosed in the present description may be arranged as follows.

(1)

An information processing apparatus including:

a sickness level estimating section that is supplied with detected information input from an acceleration sensor included in a vehicle and estimates a motion sickness level of an occupant of the vehicle while automatic driving is being carried out;

a warning outputting necessity/unnecessity determining section that compares an estimated sickness level value estimated by the sickness level estimating section and a prescribed warning output standard value with each other; and

a warning outputting executing section that executes the outputting of a warning to prompt the occupant to change from automatic driving to manual driving in a case where the estimated sickness level value becomes equal to or larger than the warning output standard value.

(2)

The information processing apparatus according to (1), further including:

an observed data acquiring section that acquires operation information of an operator after the warning has been output; and

a learning processing section that carries out a learning process based on the operation information acquired by the observed data acquiring section to calculate a warning output standard value inherent in the operator.

(3)

The information processing apparatus according to (2), in which

the learning processing section performs a warning output standard value changing process for

increasing the warning output standard value in a case where an operation of the operator after the warning has been output is decided as a normal driving operation, and

reducing the warning output standard value in case an operation of the operator after the warning has been output is decided not as a normal driving operation.

(4)

The information processing apparatus according to any one of (1) to (3), in which

the sickness level estimating section carries out a sickness level calculating process by applying a sickness level calculating equation in which the sickness level increases depending on a time during which automatic driving is continued.

(5)

The information processing apparatus according to any one of (1) to (4), in which

the sickness level estimating section is supplied with detected information input from a biological sensor included in the vehicle and estimates a motion sickness level of the occupant while automatic driving is being carried out.

(6)

The information processing apparatus according to (5), in which

the biological sensor includes a heart rate detecting sensor of the occupant.

(7)

The information processing apparatus according to (5) or (6), in which

the sickness level estimating section weights and adds two kinds of estimated sickness level values including
an estimated sickness level value calculated on a basis of the detected information from the acceleration sensor, and
an estimated sickness level value calculated on a basis of the detected information from the biological sensor,

to calculate a final estimated sickness level value of the occupant.

(8)

The information processing apparatus according to any one of (1) to (7), in which

the warning outputting necessity/unnecessity determining section is supplied with detected information input from an environmental sensor and changes the warning output standard value on a basis of an input value.

(9)

A mobile apparatus including:

an acceleration sensor for measuring an acceleration of the mobile apparatus;

a sickness level estimating section that is supplied with detected information input from the acceleration sensor and estimates a motion sickness level of an occupant of the mobile apparatus while automatic driving is being carried out;

a warning outputting necessity/unnecessity determining section that compares an estimated sickness level value estimated by the sickness level estimating section and a prescribed warning output standard value with each other; and

a warning outputting executing section that executes the outputting of a warning to prompt the occupant to change from automatic driving to manual driving in a case where the estimated sickness level value becomes equal to or larger than the warning output standard value.

(10)

The mobile apparatus according to (9), further including:

an observed data acquiring section that acquires operation information of an operator after the warning has been output; and

a learning processing section that carries out a learning process based on the operation information acquired by the observed data acquiring section to calculate a warning output standard value inherent in the operator.

(11)

The mobile apparatus according to (10), in which

the operation information of the operator acquired by the observed data acquiring section includes operation information about at least any of a handle, an accelerator, or a brake.

(12)

The mobile apparatus according to (10) or (11), in which

the learning processing section performs a warning output standard value changing process for

increasing the warning output standard value in a case where an operation of the operator after the warning has been output is decided as a normal driving operation; and

reducing the warning output standard value in case an operation of the operator after the warning has been output is decided not as a normal driving operation.

(13)

The mobile apparatus according to any one of (9) to (12), further including:

a biological sensor for acquiring biological information of the occupant, in which

the sickness level estimating section is supplied with detected information input from the biological sensor and estimates a motion sickness level of the occupant while automatic driving is being carried out.

(14)

The mobile apparatus according to (13), in which

the biological sensor includes a heart rate detecting sensor of the occupant.

(15)

The mobile apparatus according to (13) or (14), in which

the sickness level estimating section weights and adds two kinds of estimated sickness level values including
an estimated sickness level value calculated on a basis of the detected information from the acceleration sensor, and
an estimated sickness level value calculated on a basis of the detected information from the biological sensor,

to calculate a final estimated sickness level value of the occupant.

(16)

The mobile apparatus according to any one of (9) to (15), further including:

an environmental sensor for acquiring environmental information of the mobile apparatus, in which

the warning outputting necessity/unnecessity determining section is supplied with detected information input from the environmental sensor and changes the warning output standard value on a basis of an input value.

(17)

An information processing method to be carried out by an information processing apparatus, including:

a step of sickness level estimating in which a sickness level estimating section is supplied with detected information input from an acceleration sensor included in a vehicle and estimates a motion sickness level of an occupant of the vehicle while automatic driving is being carried out;

a step of warning outputting necessity/unnecessity determining in which a warning outputting necessity/unnecessity determining section compares an estimated sickness level value estimated by the sickness level estimating section and a prescribed warning output standard value with each other; and

a step of warning outputting executing in which a warning outputting executing section executes the outputting of a warning to prompt the occupant to change from automatic driving to manual driving in case the estimated sickness level value becomes equal to or larger than the warning output standard value.

(18)

An information processing method to be carried out by a mobile apparatus, including:

a step in which an acceleration sensor measures an acceleration of the mobile apparatus;

a step of sickness level estimating in which a sickness level estimating section is supplied with detected information input from the acceleration sensor and estimates a motion sickness level of an occupant of the vehicle while automatic driving is being carried out;

a step of warning outputting necessity/unnecessity determining in which a warning outputting necessity/unnecessity determining section compares an estimated sickness level value estimated by the sickness level estimating section and a prescribed warning output standard value with each other; and

a step of warning outputting executing in which a warning outputting executing section executes the outputting of a warning to prompt the occupant to change from automatic driving to manual driving in case the estimated sickness level value becomes equal to or larger than the warning output standard value.

(19)

A program for enabling an information processing apparatus to carry out information processing to cause:

a sickness level estimating section to carry out a step of sickness level estimating to be supplied with detected information input from an acceleration sensor included in a vehicle and estimate a motion sickness level of an occupant of the vehicle while automatic driving is being carried out;

a warning outputting necessity/unnecessity determining section to carry out a step of warning outputting necessity/unnecessity determining to compare an estimated sickness level value estimated by the sickness level estimating section and a prescribed warning output standard value with each other; and

a warning outputting executing section to carry out a step of warning outputting executing to execute the outputting of a warning to prompt the occupant to change from automatic driving to manual driving in case the estimated sickness level value becomes equal to or larger than the warning output standard value.

Furthermore, the sequence of processes described in the description may be hardware-implemented or software-implemented or implemented by a hybrid of hardware and software. In case the sequence of processes is software-implemented, programs in which the processing sequence is recorded may be installed in a memory in a computer incorporated in dedicated hardware and executed thereby, or may be installed in a general-purpose computer capable of performing various processes and executed thereby. For example, the programs may be recorded in a recording medium in advance. The programs may be installed from the recording medium into the computer, or may be received via a network such as a LAN (Local Area Network) or the Internet and installed into a recording medium such as a built-in hard disk or the like.

Note that the various processes described in the description may be carried out in chronological order in the sequence described above, or may be carried out parallel to each other or individually either depending on the processing capability of the apparatus that performs the processes or as required. In the present description, the term “system” means a logical collection of a plurality of apparatus, and is not limited to the arrangement in which the apparatus are present in the same housing.

### INDUSTRIAL APPLICABILITY

According to an embodiment of the present disclosure, as described above, an arrangement is realized in which the motion sickness level of an occupant of a vehicle while automatic driving is being carried out is estimated, and in case the sickness level becomes equal to or larger than an existing standard value, a warning is output to prompt the occupant to change to manual driving, making it possible to return to safe manual driving.

Specifically, for example, detected information from an acceleration sensor is input and the sickness level of an occupant of a vehicle while automatic driving is being carried out is estimated. Furthermore, in case an estimated value and a warning output standard value are compared with each other and the estimated value becomes equal to or larger than the standard value, the outputting of a warning for prompting the occupant to switch from automatic driving to manual driving is executed. Moreover, a learning process based on operation information of an operator after the warning has been output is carried out. In case the operation is decided as a normal driving operation, a standard value updating process for increasing the standard value or the like is performed to make it possible to apply a standard value inherent in the operator.

With this arrangement, the sickness level of the occupant of the vehicle while automatic driving is being carried out is estimated, and in case the sickness level becomes equal to or larger than the existing standard value, a warning is output to prompt the occupant to change to manual driving, making it possible to return to safe manual driving.

### REFERENCE SIGNS LIST

10 . . . Automobile, 11 . . . Acceleration sensor, 12 . . . biological sensor, 13 . . . Environmental sensor, 20 . . . Data processor, 21 . . . sickness level estimating section, 22 . . . Warning outputting necessity/unnecessity determining section, 23 . . . Warning outputting executing section, 24 . . . Learning processing section, 25 . . . Warning standard value storage section, 26 . . . Observed data acquiring section, 30 . . . Display unit, 50 . . . Operator, 100 . . . Vehicle control system, 101 . . . Input section, 102 . . . Data acquiring section, 103 . . . Communicating section, 104 . . . intravehicular device, 105 . . . Output controlling section, 106 . . . Output section, 107 . . . Driveline controlling section, 108 . . . Driveline system, 109 . . . Body system control section, 110 . . . Body assembly system, 111 . . . Storage section, 112 . . . Automatic driving controller, 121 . . . Communication network 131 . . . Detecting section, 132 . . . Self-position estimating section, 133 . . . Situation analyzing section, 134 . . . Planning section, 135 . . . Operation controlling section, 141 . . . Extravehicular information detecting section, 142 . . . Intravehicular information detecting section, 143 . . . Vehicle state detecting section, 151 . . . Map analyzing section, 152 . . . Traffic rule recognizing section, 153 . . . Situation recognizing section, 154 . . . Situation predicting section, 161 . . . Route planning section, 162 . . . Action planning section, 163 . . . Operation planning section, 171 . . . Emergency avoiding section, 172 . . . Acceleration and deceleration controlling section, 173 . . . Direction controlling section, 301 . . . CPU, 302 . . . ROM, 303 . . . RAM, 304 . . . Bus, 305 . . . Input/output interface, 306 . . . Input section, 307 . . . Output section, 308 . . . Storage section, 309 . . . Communicating section, 310 . . . Driver, 311 . . . Removable medium, 321 . . . Sensor, 322 . . . Driving section

1. An information processing apparatus comprising:
a sickness level estimating section that is supplied with detected information input from an acceleration sensor included in a vehicle and estimates a motion sickness level of an occupant of the vehicle while automatic driving is being carried out;
a warning outputting necessity/unnecessity determining section that compares an estimated sickness level value estimated by the sickness level estimating section and a prescribed warning output standard value with each other; and
a warning outputting executing section that executes the outputting of a warning to prompt the occupant to change from automatic driving to manual driving in a case where the estimated sickness level value becomes equal to or larger than the warning output standard value.

2. The information processing apparatus according to claim 1, further comprising:
an observed data acquiring section that acquires operation information of an operator after the warning has been output; and
a learning processing section that carries out a learning process based on the operation information acquired by the observed data acquiring section to calculate a warning output standard value inherent in the operator.

3. The information processing apparatus according to claim 2, wherein
the learning processing section performs a warning output standard value changing process for
increasing the warning output standard value in a case where an operation of the operator after the warning has been output is decided as a normal driving operation, and
reducing the warning output standard value in case an operation of the operator after the warning has been output is decided not as a normal driving operation.

4. The information processing apparatus according to claim 1, wherein
the sickness level estimating section carries out a sickness level calculating process by applying a sickness level calculating equation in which the sickness level increases depending on a time during which automatic driving is continued.

5. The information processing apparatus according to claim 1, wherein
the sickness level estimating section is supplied with detected information input from a biological sensor included in the vehicle and estimates a motion sickness level of the occupant while automatic driving is being carried out.

6. The information processing apparatus according to claim 5, wherein
the biological sensor includes a heart rate detecting sensor of the occupant.

7. The information processing apparatus according to claim 5, wherein
the sickness level estimating section weights and adds two kinds of estimated sickness level values including
an estimated sickness level value calculated on a basis of the detected information from the acceleration sensor, and
an estimated sickness level value calculated on a basis of the detected information from the biological sensor,
to calculate a final estimated sickness level value of the occupant.

8. The information processing apparatus according to claim 1, wherein
the warning outputting necessity/unnecessity determining section is supplied with detected information input from an environmental sensor and changes the warning output standard value on a basis of an input value.

9. A mobile apparatus comprising:
an acceleration sensor for measuring an acceleration of the mobile apparatus;
a sickness level estimating section that is supplied with detected information input from the acceleration sensor and estimates a motion sickness level of an occupant of the mobile apparatus while automatic driving is being carried out;
a warning outputting necessity/unnecessity determining section that compares an estimated sickness level value estimated by the sickness level estimating section and a prescribed warning output standard value with each other; and
a warning outputting executing section that executes the outputting of a warning to prompt the occupant to change from automatic driving to manual driving in a case where the estimated sickness level value becomes equal to or larger than the warning output standard value.

10. The mobile apparatus according to claim 9, further comprising:
an observed data acquiring section that acquires operation information of an operator after the warning has been output; and
a learning processing section that carries out a learning process based on the operation information acquired by the observed data acquiring section to calculate a warning output standard value inherent in the operator.

11. The mobile apparatus according to claim 10, wherein
the operation information of the operator acquired by the observed data acquiring section includes operation information about at least any of a handle, an accelerator, or a brake.

12. The mobile apparatus according to claim 10, wherein
the learning processing section performs a warning output standard value changing process for
increasing the warning output standard value in a case where an operation of the operator after the warning has been output is decided as a normal driving operation; and
reducing the warning output standard value in case an operation of the operator after the warning has been output is decided not as a normal driving operation.

13. The mobile apparatus according to claim 9, further comprising:
a biological sensor for acquiring biological information of the occupant, wherein
the sickness level estimating section is supplied with detected information input from the biological sensor and estimates a motion sickness level of the occupant while automatic driving is being carried out.

14. The mobile apparatus according to claim 13, wherein
the biological sensor includes a heart rate detecting sensor of the occupant.

15. The mobile apparatus according to claim 13, wherein
the sickness level estimating section weights and adds two kinds of estimated sickness level values including
an estimated sickness level value calculated on a basis of the detected information from the acceleration sensor, and
an estimated sickness level value calculated on a basis of the detected information from the biological sensor,
to calculate a final estimated sickness level value of the occupant.

16. The mobile apparatus according to claim 9, further comprising:
an environmental sensor for acquiring environmental information of the mobile apparatus, wherein
the warning outputting necessity/unnecessity determining section is supplied with detected information input from the environmental sensor and changes the warning output standard value on a basis of an input value.

17. An information processing method to be carried out by an information processing apparatus, comprising:
a step of sickness level estimating in which a sickness level estimating section is supplied with detected information input from an acceleration sensor included in a vehicle and estimates a motion sickness level of an occupant of the vehicle while automatic driving is being carried out;
a step of warning outputting necessity/unnecessity determining in which a warning outputting necessity/unnecessity determining section compares an estimated sickness level value estimated by the sickness level estimating section and a prescribed warning output standard value with each other; and
a step of warning outputting executing in which a warning outputting executing section executes the outputting of a warning to prompt the occupant to change from automatic driving to manual driving in case the estimated sickness level value becomes equal to or larger than the warning output standard value.

18. An information processing method to be carried out by a mobile apparatus, comprising:
a step in which an acceleration sensor measures an acceleration of the mobile apparatus;
a step of sickness level estimating in which a sickness level estimating section is supplied with detected information input from the acceleration sensor and estimates a motion sickness level of an occupant of the vehicle while automatic driving is being carried out;
a step of warning outputting necessity/unnecessity determining in which a warning outputting necessity/unnecessity determining section compares an estimated sickness level value estimated by the sickness level estimating section and a prescribed warning output standard value with each other; and
a step of warning outputting executing in which a warning outputting executing section executes the outputting of a warning to prompt the occupant to change from automatic driving to manual driving in case the estimated sickness level value becomes equal to or larger than the warning output standard value.

19. A program for enabling an information processing apparatus to carry out information processing to cause:
a sickness level estimating section to carry out a step of sickness level estimating to be supplied with detected information input from an acceleration sensor included in a vehicle and estimate a motion sickness level of an occupant of the vehicle while automatic driving is being carried out;
a warning outputting necessity/unnecessity determining section to carry out a step of warning outputting necessity/unnecessity determining to compare an estimated sickness level value estimated by the sickness level estimating section and a prescribed warning output standard value with each other; and
a warning outputting executing section to carry out a step of warning outputting executing to execute the outputting of a warning to prompt the occupant to change from automatic driving to manual driving in case the estimated sickness level value becomes equal to or larger than the warning output standard value.
